(19) United States
(12) Patent Application Publication
(10) Pub. No.: US 2023/0360196 A1
(43) Pub. Date: Nov. 9, 2023

(54) SYSTEMS AND METHODS FOR DEFECT DETECTION AND QUALITY CONTROL

(71) Applicant: Smartex Europe, Unipessoal LDA, Porto (PT)

(72) Inventors: Gilberto MARTINS LOUREIRO, Porto (PT); António ROCHA, Porto (PT); Paulo RIBEIRO, Porto (PT); Miguel Boaventura Teixeira GOMES, Porto (PT)

(21) Appl. No.: 18/163,672

(22) Filed: Feb. 2, 2023

Related U.S. Application Data
(63) Continuation of application No. PCT/IB2021/057191, filed on Aug. 5, 2021.

(30) Foreign Application Priority Data
Aug. 6, 2020 (WO) PCT/PT2020/050029

(51) Int. Cl. G06T 7/00; B65H 26/02

(52) U.S. Cl. CPC G06T 7/001; B65H 26/02; G06T 2207/20084; G06T 2207/20081; G06T 2207/30124; G06T 2207/30136; G06T 2207/30161

(57) ABSTRACT

Provided herein are systems, media, and methods for roll-to-roll material (e.g. fabric) defect detection and/or quality control based on data received from an optical detection.

### CROSS-REFERENCE

This application is a Continuation Application of International Application No. PCT/IB2021/057191 filed on Aug. 5, 2021, which claims priority to International Application No. PCT/PT2020/050029 filed on Aug. 6, 2020, each of which is incorporated herein by reference in its entirety for all purposes.

### BACKGROUND

Some roll-to-roll materials and products may be produced by high-volume manufacturing processes. Such roll-to-roll materials and products may include textiles such as natural or synthetic fabrics, structural roll-to-roll materials such as sheet metals, piping, and wood products, paper products and other roll-to-roll materials such as ceramics, composites, and plastics. Manufactured products may be produced via specialized machinery that produce such products on a continuous or batch-wise basis. For example, textiles may be produced on knitting machines that extrude a continuous sheet of knitted fabric. Manufactured products may be produced in a range of dimensions including varying lengths, widths, or thicknesses. Manufacturing equipment and machinery may include process sensing and control equipment.

### SUMMARY

Recognized herein is a need for quality control systems that may actively monitor the output from manufacturing equipment. Such quality control systems may be capable of detecting subtle or obvious manufacturing defects that may escape human detection. In some cases, defects in a manufactured product, such as needle defects in a textile product, may not be readily apparent to the human eye. In other cases, products may be released from a manufacturing process and moved to subsequent processes at a rate that exceeds the human ability to recognize and remove defective products from the product stream. Optical quality control systems may offer defect quality control capabilities over a much broader range of length scales and at much higher rates of manufacturing processivity than humans may operate. Manufacturing systems may be readily modified to include optical quality control systems that are coupled to computer systems for defect detection. In some cases, such quality control systems may be capable of isolating defective products from a product stream. In other cases, such quality control systems may be capable of recognizing defects arising from malfunctioning manufacturing equipment, thereby allowing stoppage of the defective equipment. Optical quality control systems for manufacturing equipment may permit reduced loss from the production of unsellable product, as well as reduced danger from the export of potentially unsound structural roll-to-roll materials.

One aspect provided herein is a computer-implemented method of quality control detection, the method comprising: receiving an image of the roll-to-roll material (e.g. fabric) being formed by the circular knitting machine, each image associated with the type of the roll-to-roll material (e.g. fabric), and a light source scheme implemented while the image is captured; applying a first machine learning algorithm to the type of roll-to-roll material (e.g. fabric), the image, and the light source scheme to detect the defect in the roll-to-roll material (e.g. fabric); receiving verified data regarding whether or not a defect exists in the roll-to-roll material (e.g. fabric); and feeding back the verified data to improve the first machine learning algorithm's calculation over time.

In some embodiments application is further configured to perform generating one or more simulated images of the roll-to-roll material (e.g. fabric) from the image of the roll-to-roll material (e.g. fabric), wherein the applying the first machine learning algorithm to the image comprises applying the first machine learning algorithm to the image and the simulated image. In some embodiments application is further configured to perform: applying a second machine learning algorithm to the image, the type of roll-to-roll material (e.g. fabric), and the light source scheme to detect a defect type of the defect in the roll-to-roll material (e.g. fabric); receiving verified data regarding the type of defect that exists in the roll-to-roll material (e.g. fabric); and feeding back the verified data to improve the second machine learning algorithm's calculation over time. In some embodiments application is further configured to perform generating one or more simulated images of the roll-to-roll material (e.g. fabric) from the image of the roll-to-roll material (e.g. fabric), wherein the applying the second machine learning algorithm to the image comprises applying the second machine learning algorithm to the image and the simulated image. In some embodiments first machine learning algorithm is trained by a neural network comprising: a first training module creating a first training set comprising: a first set of images, each image of the first set of images associated with the type of roll-to-roll material (e.g. fabric) and light source scheme implemented while the image is captured; and a second set of images, each image of the second set of images associated with the type of roll-to-roll material (e.g. fabric) and light source scheme implemented while the image is captured; wherein the first set of images are predetermined as displaying the defect, and wherein the second set of images are predetermined as not displaying the defect; a first training module training the neural network using the first training set; a second training module creating a second training set for second stage training comprising the first training set and the images of the second set of images incorrectly detected as having a defect after the first stage of training; and training the neural network using the second training set. In some embodiments second machine learning algorithm is trained by a neural network comprising: a first training module creating a first training set comprising: a first set of images, each image of the first set of images associated with the type of roll-to-roll material (e.g. fabric) and light source scheme implemented while the image is captured; and a second set of images, each image of the second set of images associated with the type of roll-to-roll material (e.g. fabric) and light source scheme implemented while the image is captured; wherein the first set of images are predetermined as displaying one or more of a plurality of defect types, and wherein the second set of images are predetermined as not displaying the one or more defect types; a first training module training the neural network using the first training set; a second training module creating a second training set for second stage training comprising the first training set and the images of the second set of images incorrectly detected as having a the one or more defect type after the first stage of training; and training the neural network using the second training set. In some embodiments first machine learning algorithm is trained by: constructing an initial model by assigning probability weights to predictor variables to the type of roll-to-roll material (e.g. fabric), the image of the roll-to-roll material (e.g. fabric), and the light source scheme; and adjusting the probability weights based on the verified data. In some embodiments second machine learning algorithm is trained by: constructing an initial model by assigning probability weights to predictor variables to the type of roll-to-roll material (e.g. fabric), the image of the roll-to-roll material (e.g. fabric), and the light source scheme; and adjusting the probability weights based on the verified data. In some embodiments second machine learning algorithm is trained by: a first training module creating a first training set comprising a plurality of the images, each image of the plurality of images associated with the same type of roll-to-roll material (e.g. fabric) and the same light source scheme implemented while the image is captured; wherein at most a first portion of the plurality of images are predetermined as displaying the same determined defect; a first training module training the neural network using the first training set; a second training module creating a second training set for second stage training comprising the first training set and the images not in the first portion that are incorrectly detected as having the determined defect after the first stage of training; and training the neural network using the second training set. In some embodiments application is further configured to perform: receiving the image of the roll-to-roll material (e.g. fabric), and applying a third machine learning algorithm to the image to determine a quality of the image; receiving verified data regarding the quality of the image; and feeding back the verified data to improve the third machine learning algorithm's calculation over time. In some embodiments third machine learning algorithm is trained by: a first training module creating a first training set comprising a plurality of the images, wherein a first portion of the plurality of images are predetermined as having a sufficient quality, and wherein a second portion of the plurality of images are predetermined as having an insufficient quality; a first training module training the neural network using the first training set; a second training module creating a second training set for second stage training comprising the first training set and the images in the second plurality of images incorrectly detected as having the sufficient quantity; and training the neural network using the second training set. In some embodiments third machine learning algorithm is trained by: a first training module creating a first training set comprising a plurality of the images, each image of the plurality of images associated with a quality index; a first training module training the neural network using the first training set; a second training module creating a second training set for second stage training comprising the first training set and the images in the plurality of images whose quality index was incorrectly determined beyond a set quality value; and training the neural network using the second training set; generating the one or more simulated images of the roll-to-roll material (e.g. fabric) from the image of the roll-to-roll material (e.g. fabric) comprises rotating the image, translating the image, skewing the image, modifying a brightness of the image, modifying a wavelength of the image, modifying a magnification of the image, modifying a contrast of the image, blurring the image, or any combination thereof. In some embodiments defect comprises a hole defect, a needle defect, a lycra defect, a lycra dashed defect, a yarn thickness defect, a yarn color defect, a double yarn defect, a periodicity defect, or any combination thereof. In some embodiments roll-to-roll material comprises a textile, a metal or metal alloy, a paper, or a plastic, or a wood. In some embodiments roll-to-roll material is a sheet of roll-to-roll material (e.g. fabric). In some embodiments machine is a knitting machine. In some embodiments knitting machine is a circular knitting machine. In some embodiments, the machine is a weaving machine. In some embodiments, the weaving machine is a circular weaving machine. In some embodiments, wherein the first machine learning algorithm, the second machine learning algorithm, or both, comprise an un-supervised machine learning algorithm. In some embodiments, the defect comprises a qualitative defect.

One aspect provided herein is a computer-implemented system comprising: a digital processing device comprising: at least one processor, an operating system configured to perform executable instructions, a memory, and a computer program including instructions executable by the digital processing device to create a quality control application for a roll-to-roll material configured to perform at least the following: receiving an image of the roll-to-roll material (e.g. fabric) being formed by the machine, each image associated with the type of the roll-to-roll material (e.g. fabric), and a light source scheme implemented while the image is captured, and applying a first machine learning algorithm to the type of roll-to-roll material (e.g. fabric), the image, and the light source scheme to detect the defect in the roll-to-roll material (e.g. fabric); receiving verified data regarding whether or not a defect exists in the roll-to-roll material (e.g. fabric); and feeding back the verified data to improve the first machine learning algorithm's calculation over time.

In some embodiments application is further configured to perform generating one or more simulated images of the roll-to-roll material (e.g. fabric) from the image of the roll-to-roll material (e.g. fabric), wherein the applying the first machine learning algorithm to the image comprises applying the first machine learning algorithm to the image and the simulated image. In some embodiments application is further configured to perform: applying a second machine learning algorithm to the image, the type of roll-to-roll material (e.g. fabric), and the light source scheme to detect a defect type of the defect in the roll-to-roll material (e.g. fabric); receiving verified data regarding the type of defect that exists in the roll-to-roll material (e.g. fabric); and feeding back the verified data to improve the second machine learning algorithm's calculation over time. In some embodiments application is further configured to perform generating one or more simulated images of the roll-to-roll material (e.g. fabric) from the image of the roll-to-roll material (e.g. fabric), wherein the applying the second machine learning algorithm to the image comprises applying the second machine learning algorithm to the image and the simulated image. In some embodiments first machine learning algorithm is trained by a neural network comprising: a first training module creating a first training set comprising: a first set of images, each image of the first set of images associated with the type of roll-to-roll material (e.g. fabric) and light source scheme implemented while the image is captured; and a second set of images, each image of the second set of images associated with the type of roll-to-roll material (e.g. fabric) and light source scheme implemented while the image is captured; wherein the first set of images are predetermined as displaying the defect, and wherein the second set of images are predetermined as not displaying the defect; a first training module training the neural network using the first training set; a second training module creating a second training set for second stage training comprising the first training set and the images of the second set of images incorrectly detected as having a defect after the first stage of training; and training the neural network using the second training set. In some embodiments second machine learning algorithm is trained by a neural network comprising: a first training module creating a first training set comprising: a first set of images, each image of the first set of images associated with the type of roll-to-roll material (e.g. fabric) and light source scheme implemented while the image is captured; and a second set of images, each image of the second set of images associated with the type of roll-to-roll material (e.g. fabric) and light source scheme implemented while the image is captured; wherein the first set of images are predetermined as displaying one or more of a plurality of defect types, and wherein the second set of images are predetermined as not displaying the one or more defect types; a first training module training the neural network using the first training set; a second training module creating a second training set for second stage training comprising the first training set and the images of the second set of images incorrectly detected as having a the one or more defect type after the first stage of training; and training the neural network using the second training set. In some embodiments first machine learning algorithm is trained by: constructing an initial model by assigning probability weights to predictor variables to the type of roll-to-roll material (e.g. fabric), the image of the roll-to-roll material (e.g. fabric), and the light source scheme; and adjusting the probability weights based on the verified data. In some embodiments second machine learning algorithm is trained by: constructing an initial model by assigning probability weights to predictor variables to the type of roll-to-roll material (e.g. fabric), the image of the roll-to-roll material (e.g. fabric), and the light source scheme; and adjusting the probability weights based on the verified data. In some embodiments second machine learning algorithm is trained by: a first training module creating a first training set comprising a plurality of the images, each image of the plurality of images associated with the same type of roll-to-roll material (e.g. fabric) and the same light source scheme implemented while the image is captured; wherein at most a first portion of the plurality of images are predetermined as displaying the same determined defect; a first training module training the neural network using the first training set; a second training module creating a second training set for second stage training comprising the first training set and the images not in the first portion that are incorrectly detected as having the determined defect after the first stage of training; and training the neural network using the second training set. In some embodiments application is further configured to perform: receiving the image of the roll-to-roll material (e.g. fabric), and applying a third machine learning algorithm to the image to determine a quality of the image; receiving verified data regarding the quality of the image; and feeding back the verified data to improve the third machine learning algorithm's calculation over time. In some embodiments third machine learning algorithm is trained by: a first training module creating a first training set comprising a plurality of the images, wherein a first portion of the plurality of images are predetermined as having a sufficient quality, and wherein a second portion of the plurality of images are predetermined as having an insufficient quality; a first training module training the neural network using the first training set; a second training module creating a second training set for second stage training comprising the first training set and the images in the second plurality of images incorrectly detected as having the sufficient quantity; and training the neural network using the second training set. In some embodiments third machine learning algorithm is trained by: a first training module creating a first training set comprising a plurality of the images, each image of the plurality of images associated with a quality index; a first training module training the neural network using the first training set; a second training module creating a second training set for second stage training comprising the first training set and the images in the plurality of images whose quality index was incorrectly determined beyond a set quality value; and training the neural network using the second training set. In some embodiments, generating the one or more simulated images of the roll-to-roll material (e.g. fabric) from the image of the roll-to-roll material (e.g. fabric) comprises rotating the image, translating the image, skewing the image, modifying a brightness of the image, modifying a wavelength of the image, modifying a magnification of the image, modifying a contrast of the image, blurring the image, or any combination thereof. In some embodiments defect comprises a hole defect, a needle defect, a lycra defect, a lycra dashed defect, a yarn thickness defect, a yarn color defect, a double yarn defect, a periodicity defect, or any combination thereof. In some embodiments roll-to-roll material comprises a textile, a metal or metal alloy, a paper, or a plastic, or a wood. In some embodiments roll-to-roll material is a sheet of roll-to-roll material (e.g. fabric). In some embodiments machine is a knitting machine. In some embodiments knitting machine is a circular knitting machine. In some embodiments, the machine is a weaving machine. In some embodiments, the weaving machine is a circular weaving machine. In some embodiments, wherein the first machine learning algorithm, the second machine learning algorithm, or both, comprise an un-supervised machine learning algorithm. In some embodiments, the defect comprises a qualitative defect.

One aspect provided herein is a non-transitory computer-readable storage media encoded with a computer program including instructions executable by a processor to create a quality control application for a roll-to-roll material, the application configured to perform at least the following: receiving an image of the roll-to-roll material (e.g. fabric) being formed by the machine, each image associated with the type of the roll-to-roll material (e.g. fabric), and a light source scheme implemented while the image is captured, and applying a first machine learning algorithm to the type of roll-to-roll material (e.g. fabric), the image, and the light source scheme to detect the defect in the roll-to-roll material (e.g. fabric); receiving verified data regarding whether or not a defect exists in the roll-to-roll material (e.g. fabric); and feeding back the verified data to improve the first machine learning algorithm's calculation over time.

In some embodiments application is further configured to perform generating one or more simulated images of the roll-to-roll material (e.g. fabric) from the image of the roll-to-roll material (e.g. fabric), wherein the applying the first machine learning algorithm to the image comprises applying the first machine learning algorithm to the image and the simulated image. In some embodiments application is further configured to perform: applying a second machine learning algorithm to the image, the type of roll-to-roll material (e.g. fabric), and the light source scheme to detect a defect type of the defect in the roll-to-roll material (e.g. fabric); receiving verified data regarding the type of defect that exists in the roll-to-roll material (e.g. fabric); and feeding back the verified data to improve the second machine learning algorithm's calculation over time. In some embodiments application is further configured to perform generating one or more simulated images of the roll-to-roll material (e.g. fabric) from the image of the roll-to-roll material (e.g. fabric), wherein the applying the second machine learning algorithm to the image comprises applying the second machine learning algorithm to the image and the simulated image. In some embodiments first machine learning algorithm is trained by a neural network comprising: a first training module creating a first training set comprising: a first set of images, each image of the first set of images associated with the type of roll-to-roll material (e.g. fabric) and light source scheme implemented while the image is captured; and a second set of images, each image of the second set of images associated with the type of roll-to-roll material (e.g. fabric) and light source scheme implemented while the image is captured; wherein the first set of images are predetermined as displaying the defect, and wherein the second set of images are predetermined as not displaying the defect; a first training module training the neural network using the first training set; a second training module creating a second training set for second stage training comprising the first training set and the images of the second set of images incorrectly detected as having a defect after the first stage of training; and training the neural network using the second training set. In some embodiments second machine learning algorithm is trained by a neural network comprising: a first training module creating a first training set comprising: a first set of images, each image of the first set of images associated with the type of roll-to-roll material (e.g. fabric) and light source scheme implemented while the image is captured; and a second set of images, each image of the second set of images associated with the type of roll-to-roll material (e.g. fabric) and light source scheme implemented while the image is captured; wherein the first set of images are predetermined as displaying one or more of a plurality of defect types, and wherein the second set of images are predetermined as not displaying the one or more defect types; a first training module training the neural network using the first training set; a second training module creating a second training set for second stage training comprising the first training set and the images of the second set of images incorrectly detected as having a the one or more defect type after the first stage of training; and training the neural network using the second training set. In some embodiments first machine learning algorithm is trained by: constructing an initial model by assigning probability weights to predictor variables to the type of roll-to-roll material (e.g. fabric), the image of the roll-to-roll material (e.g. fabric), and the light source scheme; and adjusting the probability weights based on the verified data. In some embodiments second machine learning algorithm is trained by: constructing an initial model by assigning probability weights to predictor variables to the type of roll-to-roll material (e.g. fabric), the image of the roll-to-roll material (e.g. fabric), and the light source scheme; and adjusting the probability weights based on the verified data. In some embodiments second machine learning algorithm is trained by: a first training module creating a first training set comprising a plurality of the images, each image of the plurality of images associated with the same type of roll-to-roll material (e.g. fabric) and the same light source scheme implemented while the image is captured; wherein at most a first portion of the plurality of images are predetermined as displaying the same determined defect; a first training module training the neural network using the first training set; a second training module creating a second training set for second stage training comprising the first training set and the images not in the first portion that are incorrectly detected as having the determined defect after the first stage of training; and training the neural network using the second training set. In some embodiments application is further configured to perform: receiving the image of the roll-to-roll material (e.g. fabric), and applying a third machine learning algorithm to the image to determine a quality of the image; receiving verified data regarding the quality of the image; and feeding back the verified data to improve the third machine learning algorithm's calculation over time. In some embodiments third machine learning algorithm is trained by: a first training module creating a first training set comprising a plurality of the images, wherein a first portion of the plurality of images are predetermined as having a sufficient quality, and wherein a second portion of the plurality of images are predetermined as having an insufficient quality; a first training module training the neural network using the first training set; a second training module creating a second training set for second stage training comprising the first training set and the images in the second plurality of images incorrectly detected as having the sufficient quantity; and training the neural network using the second training set. In some embodiments third machine learning algorithm is trained by: a first training module creating a first training set comprising a plurality of the images, each image of the plurality of images associated with a quality index; a first training module training the neural network using the first training set; a second training module creating a second training set for second stage training comprising the first training set and the images in the plurality of images whose quality index was incorrectly determined beyond a set quality value; and training the neural network using the second training set. In some embodiments, generating the one or more simulated images of the roll-to-roll material (e.g. fabric) from the image of the roll-to-roll material (e.g. fabric) comprises rotating the image, translating the image, skewing the image, modifying a brightness of the image, modifying a wavelength of the image, modifying a magnification of the image, modifying a contrast of the image, blurring the image, or any combination thereof. In some embodiments defect comprises a hole defect, a needle defect, a lycra defect, a lycra dashed defect, a yarn thickness defect, a yarn color defect, a double yarn defect, a periodicity defect, or any combination thereof. In some embodiments roll-to-roll material comprises a textile, a metal or metal alloy, a paper, or a plastic, or a wood. In some embodiments roll-to-roll material is a sheet of roll-to-roll material (e.g. fabric). In some embodiments machine is a knitting machine. In some embodiments knitting machine is a circular knitting machine. In some embodiments, the machine is a weaving machine. In some embodiments, the weaving machine is a circular weaving machine. In some embodiments, wherein the first machine learning algorithm, the second machine learning algorithm, or both, comprise an un-supervised machine learning algorithm. In some embodiments, the defect comprises a qualitative defect.

An aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, where only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory roll-to-roll material. Specifically, the following publications are incorporated herein by reference: PCT Application No. PCT/PT2020/050003; PCT Application No. PCT/PT2020/050012; PCT Application No. PCT/PT2020/050013; and PCT Application No. PCT/PT2020/050020.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 depicts a cross-sectional diagram of a circular knitting machine, in accordance with some embodiments;

FIG. 2 depicts a front-view diagram of the circular knitting machine of FIG. 1, in accordance with some embodiments;

FIG. 3 shows an image of an exemplary defect-free jersey textile, in accordance with some embodiments;

FIG. 4A shows an image of an exemplary denim textile with a hole defect, in accordance with some embodiments;

FIG. 4B shows an image of an exemplary defect-free denim textile, in accordance with some embodiments;

FIG. 5A shows an image of an exemplary textile with a needle defect, in accordance with some embodiments;

FIG. 5B shows a high magnification image of the exemplary needle defect of FIG. 5A, in accordance with some embodiments;

FIG. 6A shows an image of an exemplary textile with a lycra defect, in accordance with some embodiments;

FIG. 6B shows a high magnification image of the exemplary lycra defect of FIG. 6A, in accordance with some embodiments;

FIG. 7A shows an image of an exemplary textile with a lycra-dash defect, in accordance with some embodiments;

FIG. 7B schematically illustrates a high magnification image of the exemplary lycra-dash defect of FIG. 7A, in accordance with some embodiments;

FIG. 8 shows an image of an exemplary defect-free textile, in accordance with some embodiments;

FIG. 9 shows an image of an exemplary textile having a thick yarn defect, in accordance with some embodiments;

FIG. 10 shows a high magnification image of the exemplary thick yarn defect of FIG. 9, in accordance with some embodiments;

FIG. 11 shows an image of an exemplary textile having a thin yarn defect, in accordance with some embodiments;

FIG. 12 shows a high magnification image of the exemplary thin yarn defect of FIG. 11, in accordance with some embodiments;

FIG. 13 shows an image of an exemplary textile having a color periodicity defect, in accordance with some embodiments;

FIG. 14 shows an image of an exemplary textile having a double yarn defect, in accordance with some embodiments;

FIG. 15 shows a first image of an exemplary textile having a transition defect, in accordance with some embodiments;

FIG. 16 shows a second image of an exemplary textile having a transition defect, in accordance with some embodiments;

FIG. 17 shows a high magnification image of the exemplary transition defect of FIG. 16, in accordance with some embodiments;

FIG. 18A shows an image of an exemplary textile having a needle defect, in accordance with some embodiments;

FIG. 18B shows an image of an exemplary textile having a lycra defect and a lycra-dash defect, in accordance with some embodiments;

FIG. 19 shows an image of an exemplary textile having a needle defect and lycra defects, in accordance with some embodiments;

FIG. 20 shows an image of an exemplary textile having a pattern periodicity defect, in accordance with some embodiments;

FIG. 21 shows a non-limiting example of a computing device; in this case, a device with one or more processors, memory, storage, and a network interface, in accordance with some embodiments;

FIG. 22 shows a non-limiting example of a web/mobile application provision system; in this case, a system providing browser-based and/or native mobile user interfaces, in accordance with some embodiments;

FIG. 23 shows a flowchart of an exemplary unsupervised second machine learning algorithm, in accordance with some embodiments;

FIG. 24 shows a flowchart of an exemplary supervised second machine learning algorithm, in accordance with some embodiments;

FIG. 25 shows a flowchart of an exemplary clustered second machine learning algorithm, in accordance with some embodiments; and

FIG. 26 shows a flowchart of an exemplary third machine learning algorithm, in accordance with some embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Provided herein are systems, media, and methods for fabric defect detection and/or quality control. In some embodiments, the systems, media, and methods herein detect defects based on data received from an optical detection systems. In some cases, the systems, media, and methods for fabric defect detection are applied to quality control in a range of manufacturing products including consumable products such as textiles, sheet metals, plastics, composites, ceramics, and paper products. In some cases, the systems, media, and methods for fabric defect detection are applied to quality control in manufacturing processes that operate continuously (e.g., fabric production from a knitting machine) or in a batch-wise fashion (e.g., extrusion of refractory tiles). In some cases, the systems, media, and methods for fabric defect detection are coupled to process control systems, thereby permitting the removal of defective or substandard products or the stoppage of malfunctioning manufacturing equipment.

The systems, media, and methods for fabric defect detection permit the detection of manufacturing defects or substandard roll-to-roll materials or products over a broad range of length scales. The systems, media, and methods for fabric defect detection are capable of detecting defects or substandard roll-to-roll materials or products that are not readily apparent to the human eye, thereby permitting removal of defective products or substandard roll-to-roll materials or products from a product stream. The systems, media, and methods for fabric defect detection are capable of recognizing defects or substandard roll-to-roll materials or products in roll-to-roll materials produced at very high throughput rates where product processivity exceeds the ability of humans to recognize and remove defective products. Furthermore, implementing automated quality control or defect detection may permit enhanced process control in the absence of available quality assurance personnel, for example during night shifts.

Many roll-to-roll material defects are too small to be distinguished by the human eye, as such the methods, systems, and media herein enable detection of such defects at a higher rate and accuracy though machine learning techniques.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated. The terms “a,” “an,” and “the,” as used herein, generally refers to singular and plural references unless the context clearly dictates otherwise.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less than the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the term “roll-to-roll material” generally refers to a product of a manufacturing process that may be subsequently utilized in one or more other manufacturing processes. For example, a knitting machine may produce a fabric roll-to-roll material, which may be subsequently used to produce garments or other textile products. In another example, a metallurgical process may produce an untreated sheet metal roll-to-roll material that may be subsequently used to cut parts or be formed into piping products.

As used herein, the term “product” generally refers to a composition produced from one or more manufactured roll-to-roll materials by subsequent processing of the manufactured roll-to-roll materials. For example, a knitted fabric roll-to-roll material may be dyed, cut and sewn to produce a final garment product. A product may be an intermediate product or a final product.

As used herein, the term “defect” generally refers to an abnormality on the surface or within the volume of a roll-to-roll material or product. Defects may include non-uniformities, non-conformities, misalignments, flaws, damages, aberrations, and irregularities in the roll-to-roll material or product. As used herein, the term “regular defect” generally refers to a defect that repeats with a known pattern such as temporal recurrence, spatial recurrence, or repeating or similar morphology (e.g., holes of the same shape or size). As used herein, an “irregular defect” generally refers to a defect with a non-patterned recurrence such as temporal randomness, spatial randomness, or differing or dissimilar morphology (e.g., holes of random shapes or sizes).

As used herein, the term “quality” generally refers to a desired, predetermined, qualitative or quantitative property (or properties) of a roll-to-roll material or product. A quality may encompass a plurality of properties that collectively form a standard for a roll-to-roll material. For example, a quality of a textile may refer to a weight, color, thread count, thickness of the textile, fabric uniformity, smoothness, yarn uniformity, yarn thickness, absence of contaminations, or a combination thereof. As used herein, the term “substandard quality” generally refers to a roll-to-roll material or product that fails to meet at least one quality control standard or benchmark for a desired property. In some cases, a substandard roll-to-roll material or product may fail to meet more than one quality control standard or benchmark.

As used herein, the term “quality control” generally refers to a method of comparing a manufactured roll-to-roll material or product to an established quality control standard or benchmark. A quality control method may comprise measuring one or more observable properties or parameters (e.g., length, width, depth, thickness, diameter, circumference, shape, color, density, weight, strength, etc.) of a manufactured roll-to-roll material or product. Quality control may comprise comparison of one or more parameters of a roll-to-roll material or product to a known benchmark or monitoring of variance of one or more parameters during a manufacturing process. Quality control may be qualitative (e.g., pass/fail) or quantitative (e.g., statistical analysis of measured parameters). A manufacturing process may be considered to meet a quality control standard if the variance of at least one roll-to-roll material or product parameter is within about ±1%, ±2%, ±3%, ±4%, ±5%, ±6%, ±7%, ±8%, ±9%, or about ±10% of a quality control standard or benchmark.

As used herein, the term “calibrate,” “calibrating,” or “calibration” generally refers to calibrating one or more imaging units to one or more target regions of a roll-to-roll material sheet. The calibrating may include providing the imaging unit(s) in a predetermined spatial configuration relative to a roll-to-roll material fabrication machine that is useable to form the roll-to-roll material sheet. The calibrating may also include providing the one or more imaging units in a predetermined spatial configuration for imaging the one or more target regions, such that the imaging unit(s) are in focus on the target region(s), and with the target region(s) lying within a field of view of the imaging unit(s). As used herein, the term “target region(s)” may generally refer to one or more regions that are defined on a roll-to-roll material sheet. The target region(s) may be of any predetermined shape, size or dimension.

The term “real-time,” as used herein, generally refers to a simultaneous or substantially simultaneous occurrence of a first event or action with respect to occurrence of a second event or action. A real-time action or event may be performed within a response time of less than one or more of the following: ten seconds, five seconds, one second, tenth of a second, hundredth of a second, a millisecond, or less relative to at least another event or action. A real-time action may be performed by one or more computer processors.

As used herein, the term “software,” “algorithm,” “machine executable code,” “computer program” and the like, generally refers to a sequence of instructions, executable by one or more processor(s) of the computing device's CPU, written to perform a specified task

As used herein, the term “non-transitory computer readable medium” generally refers to tangible computer-readable storage media, such as memory, storage, a storage devices, or a storage medium.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1. Optical Detection Systems

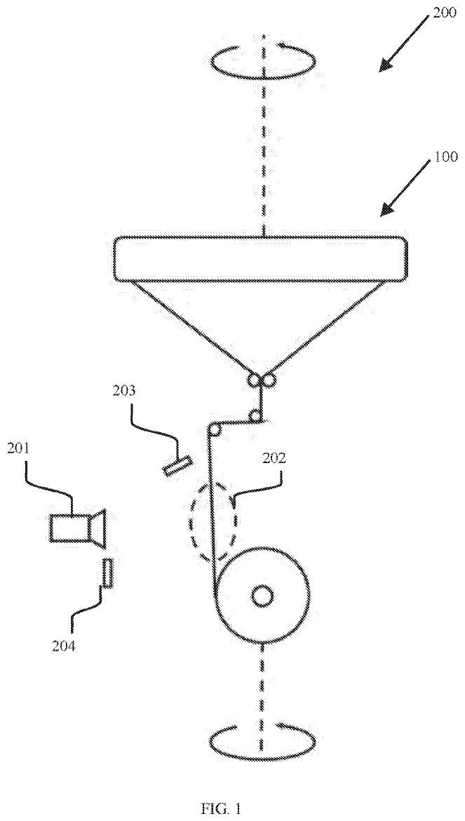

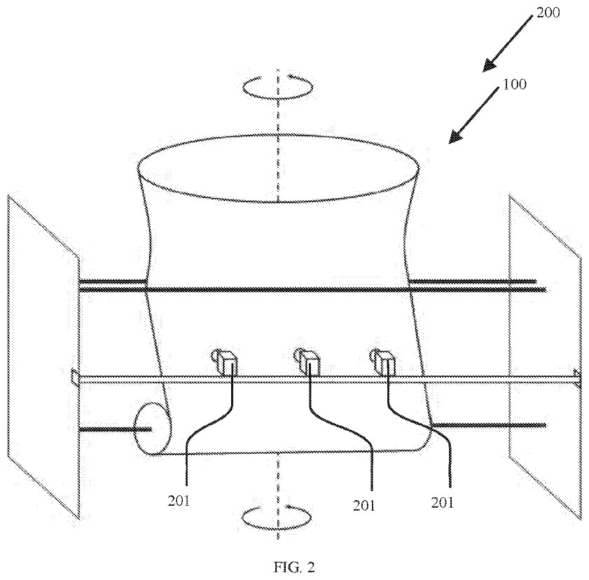

In some embodiments, systems, media, and methods for fabric defect detection may receive data from an optical detection system 200. Per FIGS. 1 and 2, the optical detection system 200 may be configured for use with a circular knitting machine 100. Further, as shown, the optical detection system 200 comprises a camera device 201 configured to capture an image of a target region 202. In some embodiments, the target region 202, is illuminated by a first light source 203, a second light source 204, or both. In some embodiments, per FIG. 2, the optical detection system 200 comprises three camera devices 201. Alternatively, in some embodiments, the optical detection system 200 comprises 4, 5, 6, 7, 8, 9, 10, or more camera devices 201.

In some embodiments, the optical detection system 200 are intended to adapt to existing manufacturing equipment rather than necessitate the redesign of existing system 200 to accommodate the new detection systems 200. Broadly speaking, the optical detection systems 200 may include one or more sensor systems 200 coupled to a computer system 200 capable of implementing the systems 200, media, and methods for fabric defect detection herein. In some cases, an optical sensor may include a camera device 201. Optionally, the optical detection system 200 may further include one or more light sources 203 204 for illuminating the manufactured roll-to-roll materials. The sensor system 200 may transmit collected data to a computer system 200 by a wireless data connection, a wired data connection, or a combination of wired/wireless data connections.

The optical detection system 200 may be further integrated with the process control hardware or software to enable improved process control. The optical detection system 200 may be capable of recognizing regular or repeating defects or regular substandard roll-to-roll materials or products that may evidence a broken or malfunctioning manufacturing device. The optical detection algorithm may be programmed to alert a human operator or automatically stop a manufacturing process if a defect detection rate exceeds a threshold level or a quality control standard falls below a threshold level. In some embodiments, the circular knitting screen with an optical detection system 200 comprises a display terminal. The display terminal may be capable of providing process information and warnings regarding defects or substandard roll-to-roll materials or products to a human operator. The display terminal may provide control functions to a human operator that allow intervention in the case of a malfunctioning machine. In some cases, the display terminal may comprise a handheld, mobile, or portable device (e.g., a tablet or cell phone). In some cases, the display terminal may comprise a remote computer terminal. In some cases, the display terminal may be connected to the optical detection system 200 through a wireless or cloud computing link.

Optical detection systems 200 may be implemented at any stage or step in roll-to-roll material or product production, including during the fabrication of the roll-to-roll material or product and any subsequent processing steps after fabrication. Optical detection systems 200 may be capable of detecting one or more types or modes of defect or substandard roll-to-roll materials or products in a manufactured product or roll-to-roll material. Optical detection systems 200 may be physically integrated within a manufacturing device to permit defect detection or quality control in real time during the roll-to-roll material or product manufacturing process.

The optical detection system 200 may comprise an imaging unit, a data transmission link, and a computer system 200. Optionally, the optical detection system 200 may comprise additional structural components that increase the utility of the system 200. The imaging unit of an optical detection device may comprise one or more light sources 203 204 or illumination units and one or more detection devices. In some cases, an optical imaging system 200 may comprise no additional light sources 203 204 or illumination units.

The imaging unit of an optical detection system 200 may broadly encompass any system 200 capable of detecting roll-to-roll material defects or substandard roll-to-roll materials or products via the transmission, reflection, refraction, scattering or absorbance of light. Defects on a roll-to-roll material or product surface or body may have a characteristic behavior in the presence of a light source 203 204. For example, holes, tears, blockages, or occlusions may all be characterized by changes in the transmission of light. In another examples, surface flaws such as pits or bulges may be detected by changes in the reflection or scattering patterns of an impinging light source 203 204. Substandard roll-to-roll materials may be measured by bulk parameters or may be assessed by other measures such as statistical analysis of detected defects.

An imaging unit may comprise one or more light sources 203 204 or illumination units. A light source 203 204 or illumination unit may comprise a single light, a group of lights, or a series of lights. A light source 203 204 or illumination unit in an imaging unit may comprise a substantially monochromatic light source 203 204 or a light source 203 204 with a characteristic frequency or wavelength range. Exemplary light sources 203 204 or illumination units may include x-ray sources, ultraviolet (UV) sources, infrared sources, LEDs, fluorescent lights, and lasers. A light source 203 204 or illumination unit may emit within a defined region of the electromagnetic spectrum, such as x-ray, UV, UV-visible, visible, near-infrared, far-infrared, or microwave. A light source 203 204 or illumination unit may have a characteristic wavelength of about 0.1 nm, 1 nm, 10 nm, 100 nm, 200 nm, 300 nm, 400 nm, 500 nm, 600 nm, 700 nm, 800 nm, 900 nm, 1 μm, 10 μm, 100 μm, 1 mm, or more than about 1 mm. A light source 203 204 or illumination unit may have a characteristic wavelength of at least about 0.1 nm, 1 nm, 10 nm, 100 nm, 200 nm, 300 nm, 400 nm, 500 nm, 600 nm, 700 nm, 800 nm, 900 nm, 1 μm, 10 μm, 100 μm, 1 mm, or more than 1 mm. A light source 203 204 or illumination unit may have a characteristic wavelength of no more than about 1 mm, 100 μm, 10 μm, 1 μm, 900 nm, 800 nm, 700 nm, 600 nm, 500 nm, 400 nm, 300 nm, 200 nm, 100 nm, 10 nm, 1 nm, 0.1 nm, or less than about 0.1 nm. A light source 203 204 or illumination unit may emit a range of wavelengths, for example in a range from about 1 nm to about 10 nm, about 1 nm to about 100 nm, about 10 nm to about 100 nm, about 10 nm to about 400 nm, about 100 nm to about 500 nm, about 100 nm to about 700 nm, about 200 nm to about 500 nm, about 400 nm to about 700 nm, about 700 nm to about 1 μm, about 700 nm to about 10 μm, about 1 μm to about 100 μm, or about 1 μm to about 1 mm.

An imaging unit may comprise more than one light source 203 204 or illumination unit. An imaging unit may comprise more than one light source 203 204 or illumination unit with similar or overlapping wavelengths or wavelength ranges. An imaging unit may comprise more than one light source 203 204 or illumination unit with differing wavelengths or wavelength ranges, e.g., a UV light source 203 204 and a visible light source 203 204. An imaging unit may comprise more than one light source 203 204 or illumination unit to permit more than one type of defect or quality detection. An imaging unit may comprise more than one light source 203 204 or illumination unit to eliminate shadowing artifacts or alter the depth of field during imaging of a roll-to-roll material or product. In some cases, an optical imaging system 200 may comprise no additional light sources 203 204 or illumination units. In some cases, an optical detection system 200 may be configured to collect ambient light at a detection unit.

A light source 203 204 or illumination unit may further comprise additional optical components for altering or shaping the emitted light. A light source 203 204 may be collimated, uncollimated, polarized, or unpolarized. A light source 203 204 or illumination unit may in a unidirectional or multidirectional fashion. A light source 203 204 or illumination unit and/or detection unit may be oriented relative to a surface of a roll-to-roll material. The orientation of a light source 203 204 or illumination unit and/or detection unit relative to a surface of a roll-to-roll material or product may be substantially horizontal or low angle. The orientation of a light source 203 204 relative to a surface of a roll-to-roll material or product may be substantially orthogonal. A light source 203 204 or illumination unit and/or detection unit may be oriented relative to a plane or surface at about Oo, 1o, 2o, 3o, 4o, 5o, 6o, 7o, 8o, 9o, 10o, 11o, 12o, 13o, 14o, 15o, 16o, 17o, 18o, 190, 20o, 21o, 22o, 23o, 24o, 25o, 26o, 27o, 28o, 29o, 30o, 31o, 32o, 33o, 34o, 35o, 36o, 37o, 38o, 39o, 40o, 41o, 42o, 43o, 44o, 45o, 46o, 47o, 48o, 49o, 50o, 51o, 52o, 53o, 54o, 55o, 56o, 57o, 58o, 59o, 60o, 61o, 62o, 63o, 64o, 65o, 66o, 67o, 68o, 69o, 70o, 71o, 72o, 73o, 74o, 75o, 76o, 77o, 78o, 79o, 80o, 81o, 82o, 83o, 84o, 85o, 86o, 87o, 88o, 89o, 90o, 105o, 120o, 135o, 150o, 165o, or about 1800. A light source 203 204 or illumination unit and/or detection unit may be oriented relative to a plane or surface at least about Oo, 1o, 2o, 3o, 4o, 5o, 6o, 7o, 8o, 9o, 10o, 11o, 12o, 13o, 14o, 15o, 16o, 17o, 18o, 19o, 20o, 21o, 22o, 23o, 24o, 25o, 26o, 27o, 28o, 29o, 30o, 31o, 32o, 33o, 34o, 35o, 36o, 37o, 38o, 39o, 40o, 41o, 42o, 43o, 44o, 45o, 46o, 47o, 48o, 49o, 50o, 51o, 52o, 53o, 54o, 55o, 56o, 57o, 58o, 59o, 60o, 61o, 62o, 63o, 64o, 65o, 66o, 67o, 68o, 69o, 70o, 71o, 72o, 73o, 74o, 75o, 76o, 77o, 78o, 79o, 80o, 81o, 82o, 83o, 84o, 85o, 86o, 87o, 88o, 89o, or more than about 90o, 105o, 120o, 135o, 150o, 165o, or more than about 165o. A light source 203 204 or illumination unit and/or detection unit may be oriented relative to a plane or surface at no more than about 180o, 165o, 150o, 135o, 120o, 105o, 90o, 89o, 88o, 87o, 86o, 85o, 84o, 83o, 82o, 81o, 80o, 79o, 78o, 77o, 76o, 75o, 74o, 73o, 72o, 71o, 70o, 69o, 68o, 67o, 66o, 65o, 64o, 63o, 62o, 61o, 60o, 59o, 58o, 57o, 56o, 55o, 54o, 53o, 52o, 51o, 50o, 49o, 48o, 47o, 46o, 45o, 44o, 43o, 42o, 41o, 40o, 39o, 38o, 37o, 36o, 35o, 34o, 33o, 32o, 31o, 30o, 29o, 28o, 27o, 26o, 25o, 24o, 23o, 22o, 21o, 20o, 190, 18o, 17o, 16o, 15o, 14o, 13o, 12o, 11o, 10o, 9o, 8o, 7o, 6o, 5o, 4o, 3o, 2o, 1o, or less than about 1o.

An imaging unit may comprise one or more detection units or detectors. A detection unit or detector as used herein may serve as an image capture and/or scanning device. An imaging device may be a physical imaging device. A detection unit or detector may be configured to detect electromagnetic radiation (e.g., visible, infrared, and/or ultraviolet light) and generate image data based on the detected electromagnetic radiation. A detection unit or detector may include a charge-coupled device (CCD) sensor, photomultiplier, or a complementary metal-oxide-semiconductor (CMOS) sensor that generates electrical signals in response to wavelengths of light. The resultant electrical signals may be processed to produce image data. In some cases, the detection unit or detector may comprise a frame difference camera 201. Data from a frame difference camera 201 may comprise data on the differences between two or more images. Data from a frame difference camera 201 may comprise an image or a video. The image data generated by a detection unit or detector may include one or more images, which may be static images (e.g., visual codes, photographs), dynamic images (e.g., video), or suitable combinations thereof. The image data may be polychromatic (e.g., RGB, CMYK, HSV) or monochromatic (e.g., grayscale, black-and-white, sepia). The detection unit or detector may include additional optical components, such as shutters, filters, or lenses configured to direct light onto an image sensor.

In some embodiments, the detection unit or detector may be a camera 201. A camera 201 may be a movie or video camera 201 that captures dynamic image data (e.g., video). A camera 201 may be a still camera 201 that captures static images (e.g., photographs). A camera 201 may capture both dynamic image data and static images. A camera 201 may switch between capturing dynamic image data and static images. Although certain embodiments provided herein are described in the context of camera 201s, it shall be understood that the present disclosure may be applied to any suitable imaging device, and any description herein relating to camera 201s may also be applied to any suitable imaging device, and any description herein relating to camera 201s may also be applied to other types of imaging devices. A camera 201 may be used to generate 2D images of a 3D code. The images generated by the camera 201 may represent the projection of the 3D code onto a 2D image plane. Accordingly, each point in the 2D image corresponds to a 3D spatial coordinate in the 3D code. The camera 201 may comprise optical elements (e.g., lens, mirrors, filters, etc). The camera 201 may capture color images, greyscale image, infrared images, and the like. The camera 201 may be a thermal imaging device when it is configured to capture infrared images. A detection device may capture one-dimensional (1D, two-dimensional (2D), or three-dimensional (3D) data.

A camera 201 system 200 may further comprise one or more optical components such as lenses. Lenses may be configured with camera 201 systems 200 to increase the image resolution, or increasing or decreasing the focal length of the camera 201 system 200.

The detection unit or detector may capture an image or a sequence of images at a specific image size. In some embodiments, the image size may be defined by the number of pixels in an image. In some embodiments, the image size may be greater than or equal to about 352×420 pixels, 480×320 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels. In some embodiments, the camera 201 may be a 4K camera 201 or a camera 201 with a higher image size.

The detection unit or detector may capture a sequence of images at a specific capture rate. In some embodiments, the sequence of images may be captured standard video frame rates such as about 24p, 25p, 30p, 48p, 50p, 60p, 72p, 90p, 100p, 120p, 300p, 50i, or 60i. In some embodiments, the sequence of images may be captured at a rate less than or equal to about one image every 0.0001 seconds, 0.0002 seconds, 0.0005 seconds, 0.001 seconds, 0.002 seconds, 0.005 seconds, 0.01 seconds, 0.02 seconds, 0.05 seconds. 0.1 seconds, 0.2 seconds, 0.5 seconds, 1 second, 2 seconds, 5 seconds, or 10 seconds. In some embodiments, the capture rate may change depending on user input and/or the target application.

The detection unit or detector may have a characteristic image resolution. The image resolution may be defined as the length at which image features are optically resolvable. For example, a camera 201 with an image resolution of 0.1 mm may be capable of distinguishing features of 0.1 mm or larger. A detection unit or detector may have an image resolution of about 0.01 mm, 0.05 mm, 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, or more than about 5 mm. A detection unit or detector may have an image resolution of at least about 0.01 mm, 0.05 mm, 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, or more than about 5 mm. A detection unit or detector may have an image resolution of no more than about 5 mm, 4 mm, 3 mm, 2 mm, 1 mm, 0.9 mm, 0.8 mm, 0.7 mm, 0.6 mm, 0.5 mm, 0.4 mm, 0.3 mm, 0.2 mm, 0.1 mm, 0.05 mm, 0.01 mm, or less than about 0.01 mm.

The detection unit or detector may have adjustable parameters. Under differing parameters, different images may be captured by the detection unit or detector while subject to identical external conditions (e.g., location, lighting). The adjustable parameter may comprise exposure (e.g., exposure time, shutter speed, aperture, film speed), gain, gamma, area of interest, binning/subsampling, pixel clock, offset, triggering, ISO, etc. Parameters related to exposure may control the amount of light that reaches an image sensor in the imaging device. For example, shutter speed may control the amount of time light reaches an image sensor and aperture may control the amount of light that reaches the image sensor in a given time. Parameters related to gain may control the amplification of a signal from the optical sensor. ISO may control the level of sensitivity of the camera 201 to available light. Parameters controlling for exposure and gain may be collectively considered and be referred to herein as EXPO.

In some alternative embodiments, a detection unit or detector may extend beyond a physical imaging device. For example, a detection unit or detector may include any technique that is capable of capturing and/or generating images or video frames of codes. In some embodiments, the detection unit or detector may refer to an algorithm that is capable of processing images obtained from another physical device.

Detection units, detectors or sensors may be arranged in a serial fashion to increase the field of vision. Detection devices may be arranged such that each devices' respective field of vision overlaps with the field of vision of a neighboring device. Detection devices may be arranged such that each devices' field of vision is immediately adjacent to the field of vision of a neighboring device. Exemplary fields of vision may be achieved with one or more camera 201 units where each camera 201 has a 300 mm by 225 mm field of vision and the camera 201s are configured to overlap by 25 mm. Camera 201 configurations may be chosen for defect analysis or quality control of fabric manufacturing processes based upon the width of the manufactured fabric roll-to-roll material.

An item having a visual code as described herein may be optically identified and/or tracked in real-time by a visual scanning system 200. Optical tracking has several advantages. For example, optical tracking allows for wireless ‘sensors’, is less susceptible to noise, and allows for many objects (e.g., different types of objects) to be tracked simultaneously. The objects may be depicted in still images and/or video frames in a 2D or 3D format, may be real-life and/or animated, may be in color, black/white, or grayscale, and may be in any color space. In some cases, data from linear camera(s) 201 (1D signal) may be aggregated in order to build a 2D signal that captures the full detail of the 2D target region 202.

An optical detection system 200 may comprise a data transmission link to facilitate the transfer of imaging data from the imaging unit to a computer system 200. A data transmission link may comprise a hardwired link or a wireless link. A hardwired link may include any type of cable capable of transmitting a digital or electrical signal from the imaging unit to the computer system 200. A data transmission link may include additional components such as hubs, routers, antennae, modems, and receivers.

An optical detection system 200 may comprise a computer system 200. A computer system 200 may be configured to receive data (e.g., 1D or 2D images) from an imaging unit and interpret the data to identify and/or quantify the incidence of defects during a manufacturing process. A computer system 200 may comprise one or more algorithms for interpreting imaging data to determine the presence of defects or substandard roll-to-roll materials or products in a manufactured roll-to-roll material or product. An algorithm may be a standalone software package or application for defect detection. An algorithm may be integrated with other operational software for a manufacturing device, such as process control software. An algorithm for defect detection or quality control may be configured to affect the operation of a manufacturing process. For example, a defect detection algorithm or quality control algorithm may be configured to stop or slow a manufacturing process if one or more defects are detected in a roll-to-roll material or product or a roll-to-roll material or product falls beneath a quality control standard for a certain amount of time. A defect detection algorithm or quality control algorithm may be capable of identifying one or more types of defects or quality levels in a manufactured roll-to-roll material or product. A defect detection algorithm or quality control algorithm may be capable of identifying a root cause of one or more types of defects or substandard roll-to-roll materials or products based upon the number of defects, the number density of defects, the frequency of defects, the regularity of defects, the size of defects, the shape of defects, or any other relevant parameters that may be calculated by the algorithm. A defect detection algorithm or quality control algorithm may utilize defect data to stop or alter a manufacturing process. A defect detection algorithm or quality control algorithm may correct one or more processing parameters to reduce the rate of defect formation or improve the quality of a roll-to-roll material or product during a manufacturing process. A defect detection algorithm or quality control algorithm may identify an unusable, unsellable, or otherwise compromised roll-to-roll material or product obtained from a manufacturing process. A roll-to-roll material or product may be discarded, repaired, or reprocessed based upon the identification of one or more defects or substandard quality by a defect detection algorithm or quality control algorithm. A defect detection algorithm or quality control algorithm may comprise a trained algorithm or a machine learning algorithm.

A defect detection algorithm or quality control algorithm may comprise a trained algorithm or a machine learning algorithm. In some cases, the defect detection algorithm or quality control algorithm may comprise a machine vision algorithm. The defect detection algorithm or quality control algorithm may comprise various sub-algorithms or subroutines such as variance analysis, Gaussian kernel convolution, machine learning model (e.g., section profile analysis), local binary pattern analysis, gradient analysis, and Hough transform analysis.

An optical detection system 200 may comprise further mechanical and/or electrical components. Structural components may be utilized to secure components of the optical detection system 200 in, on, or around a manufacturing device. The optical detection system 200 may be a modular system 200. The optical detection system 200 may be an adjustable system 200 capable of adapting to a range of manufacturing devices. An optical detection system 200 may be a customized device that is specifically designed for a particular manufacturing device. A structural component may comprise a mount that attaches one or more components of an imaging unit to a manufacturing device. In some cases, components may be configured in static positions relative to the output of a manufacturing device. In some cases, components of an imaging unit may be mounted to static supports by motive components such that the static support may remain fixed while the imaging unit component may be repositioned during operation. In other cases, an imaging unit component may be mounted to a moving component of a manufacturing device such that the component is moved by the movement of the manufacturing device. For example, a camera 201 unit may be mounted to a rotational element of a machine (e.g. circular knitting machine) such that the camera 201 rotates during operation of the knitting machine. In some cases, an imaging unit component may be configured to move with a velocity that matches the velocity of a moving portion of the manufacturing machine. In some cases, an imaging unit component may be configured to move with a differing velocity from that of a moving portion of the manufacturing machine. For example, an imaging unit may be directly coupled to a rotating portion of a machine (e.g. circular knitting machine), or the imaging unit may be indirectly coupled to the rotating portion by a gear assembly to cause the imaging unit to rotate at a faster or slower speed than the rotating portion.

An optical detection may comprise additional mechanical components. Mechanical components may include structural components, motive devices, and shielding components. Structural components may include any components that hold, attach, or support components of the optical detection system 200. Structural components may also include devices for other mechanical purposes such as vibration dampening. Structural components may include bars, struts, clamps, brackets, rods, pins, plates, screws, nails, bolts, rivets, washers, and nuts. Motive devices may include motorized stages or carts for moving components translationally or rotationally. Motive components may be used to alter or reposition components (e.g., camera, light sources) before, during or after the collection of imaging data. In some cases, motive components may be used to configured or optimize the position of components of the optical detection system 200 after installation in a manufacturing device. In other cases, motive components may be utilized to alter the position of system 200 components during data collection. An optical detection system 200 may comprise shielding components to protect the system 200 from environmental hazards such as heat, contaminants, and interfering ambient light sources 203 204.

The mechanical components of an optical detection system 200 may be adjustable or modular. Components intended to secure, couple or attach an imaging system 200 to a manufacturing device may contain adjustable components that permit adaptation between systems 200. Such a configuration would permit adjustment of the imaging unit relative to the manufactured roll-to-roll material or product, thereby permitting alteration of the target region 202. Adjustable components ma further incorporate manual, automated or user-controlled adjustments to permit adjustment of the imaging unit before, during, or after utilization. Structural components may permit 1 degree of freedom for adjustment, 2 degrees of freedom for adjustment, or permit up to 360o of rotational adjustment.

In some cases, an imaging unit may be coupled to a manufacturing machine by a structural support. The structural support holding the imaging unit may be coupled to a portion of the manufacturing device such as a wall, lateral support, roof, floor, or surface. The structural support holding the imaging support may be coupled to a stationary or fixed portion of the manufacturing machine. The structural support holding the imaging support may be coupled to a rotating, translating, oscillating, or otherwise moving portion of a manufacturing machine, such as a rotating shaft or a rotating support. In some cases, the structural support may comprise a stand-alone structure that is not directly coupled to the manufacturing machine.

An optical detection system 200 may further comprise electrical components. Electrical components may provide power to any component of the system 200 requiring electrical energy.

Exemplary electrical components may include wiring, batteries, plugs, sockets, and insulating shielding.

### Defect Detection Systems, Media, and Methods

Provided herein are computer-implemented methods, non-transitory computer-readable storage media and computer-implemented systems encoded with a computer program including instructions executable by a processor to create a quality control application for a roll-to-roll material. In some embodiments, the method, the application, or both may detect one or more defects in one or more roll-to-roll materials (e.g. fabric), or may be used to maintain quality control during production of the roll-to-roll material. In some embodiments, the method, the application, or both may detect one or more defects in one or more roll-to-roll materials (e.g. fabric) produced by a machine (e.g. circular knitting machine), or may be used to maintain quality control as the one or more fabrics are being produced by the circular knitting machine.

In some embodiments, the method comprises and/or the application may be configured to perform one or more of the following steps: (a) receiving an image of the fabric being formed by a machine (e.g. circular knitting machine), each image associated with the type of the fabric, and a light source scheme implemented while the image is captured, applying a first machine learning algorithm to the type of fabric, the image, and the light source scheme to detect the defect in the fabric; (b) receiving verified data regarding whether or not one or more defects exists in the fabric; (c) feeding back the verified data to improve the first machine learning algorithm's calculation over time. In some embodiments, the image of the fabric being formed by the machine (e.g. circular knitting machine) may be received in real-time.

In some embodiments, the method may comprise and/or the application may be further configured to generate one or more simulated images of the fabric from the image of the fabric. In some embodiments, applying the first machine learning algorithm to the image may comprise applying the first machine learning algorithm to the image and the simulated image. In some embodiments, the method comprises and/or the application may be further configured to: (a) apply a second machine learning algorithm to the image, the type of fabric, and the light source scheme to detect one or more defect types of the defect in the fabric; (b) receive verified data regarding the type of defect that exists in the fabric; and (c) feed back the verified data to improve the second machine learning algorithm's calculation over time. In some embodiments, the method comprises and/or the application may be further configured to perform generating one or more simulated images of the fabric from the image of the fabric. In some embodiments, applying the second machine learning algorithm to the image comprises applying the second machine learning algorithm to the image and the simulated image.

In some embodiments, the type of the fabric, the light source scheme implemented while the image is captured, or both may be received from an operator of the machine. In some embodiments, the type of the fabric, the light source scheme implemented while the image is captured, or both may be received based on a fabric part number being produced on the machine. In some embodiments, the type of the fabric, the light source scheme implemented while the image is captured, or both may be determined by a machine learning algorithm. In some embodiments, the type of the roll-to-roll material (i.e. fabric) is manually entered by a machine operator, an administrator, or both. In some embodiments, the type of the roll-to-roll material (i.e. fabric) is determined by a machine learning method (i.e. one or more of the machine learning methods herein). In some embodiments, each image is only associated with the light source scheme. In some embodiments, each image is only associated with the roll-to-roll material type. In some embodiments, each image is not associated with the light source scheme, the fabric type, or both.

In some embodiments, generating the one or more simulated images of the fabric from the image of the fabric comprises rotating the image, translating the image, skewing the image, modifying a brightness of the image, modifying a wavelength of the image, modifying a magnification of the image, modifying a contrast of the image, blurring the image, or any combination thereof. In some embodiments, at least one of the one or more simulated images of the fabric may be associated with the light source scheme. In some embodiments, the light source scheme may be associated with a lighting condition in a specific factory, in a specific machine, at a specific date, or any combination thereof. In some embodiments, generating the one or more simulated images of the fabric from the image of the fabric enables the use of a greater quantity of training images from those captured, annotated, or both. In some embodiments, the first machine algorithm, the second machine algorithm, or both may be further configured to augment the image of the fabric being formed by the machine (e.g. circular knitting machine) with an indicator displaying one or more locations of the defect, one or more types of the defect, or both. In some embodiments, generating the one or more simulated images of the fabric comprises pasting an image of a defect copied from an image predetermined as having a defect.

In some embodiments, the first machine learning algorithm may be trained by a neural network comprising: a first training module creating a first training set comprising: a first set of images, each image of the first set of images associated with the type of fabric and light source scheme implemented while the image is captured; a second set of images, each image of the second set of images associated with the type of fabric and light source scheme implemented while the image is captured; wherein the first set of images may be predetermined as displaying the defect, and wherein the second set of images may be predetermined as not displaying the defect; a first training module training the neural network using the first training set; a second training module creating a second training set for second stage training comprising the first training set and the images of the second set of images incorrectly detected as having one or more defects after the first stage of training; training the neural network using the second training set. In some embodiments, the first machine learning algorithm may be trained by: (a) constructing an initial model by assigning probability weights to predictor variables to the type of fabric, the image of the fabric, and the light source scheme; and (b) adjusting the probability weights based on the verified data. In some embodiments, the second machine learning algorithm may be trained by: constructing an initial model by assigning probability weights to predictor variables to the type of fabric, the image of the fabric, and the light source scheme; and adjusting the probability weights based on the verified data.

In some embodiments, the second machine learning algorithm may be trained by a neural network comprising: a first training module creating a first training set comprising: a first set of images, each image of the first set of images associated with the type of fabric and light source scheme implemented while the image is captured; a second set of images, each image of the second set of images associated with the type of fabric and light source scheme implemented while the image is captured; wherein the first set of images may be predetermined as displaying one or more of a plurality of defect types, and wherein the second set of images may be predetermined as not displaying the one or more defect types; a first training module training the neural network using the first training set; a second training module creating a second training set for second stage training comprising the first training set and the images of the second set of images incorrectly detected as having the one or more defect types after the first stage of training; training the neural network using the second training set. In some embodiments, the second machine learning algorithm may be trained by: a first training module creating a first training set comprising a plurality of the images, each image of the plurality of images associated with the same type of fabric and the same light source scheme implemented while the image is captured; wherein at most a first portion of the plurality of images may be predetermined as displaying the same determined defect; a first training module training the neural network using the first training set; a second training module creating a second training set for second stage training comprising the first training set and the images not in the first portion that are incorrectly detected as having the determined defect after the first stage of training; training the neural network using the second training set. In some embodiments, training the neural network using the first training set, using the second training set, or both, comprises training with two or more images simultaneously.

In some embodiments, the light source scheme comprises a quantity of lights, a position of one or more lights, a brightness of one or more lights, a direction of one more lights relative to the roll-to-roll material (e.g. fabric), a direction of the camera relative to the roll-to-roll material (e.g. fabric), a quantity of cameras, a spacing between one or more of the cameras, or any combination thereof.

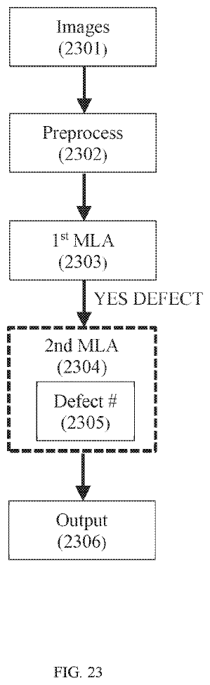

FIG. 23 shows a flowchart of an exemplary unsupervised method to detect one or more defects in a roll-to-roll material (e.g. fabric) or to maintain quality control during production of the roll-to-roll material. As shown, in some embodiments, the images 2301 may be preprocessed 2302. In some embodiments, preprocessing removes noise in the images 2301, improves the lighting and conditions of the images 2301, crops the images 2301, or any combination thereof. In some embodiments, the 5, 10, 20, 30, 40, 50, 75, 100, 125, 150, 200, 250, 300, 400, 500, 750, 1,000, 5,000, 10,000 or more images 2301 may be preprocessed 2302. In some embodiments, the images may be obtained from or associated with a machine, for example a Circular Knitting Machine (CKM). In some embodiments, the preprocessed images may be input into a first machine learning algorithm 2303. In some embodiments, the first machine learning algorithm 2303 determines whether or not one or more defects may be displayed in the preprocessed images 2302. In some embodiments, the first machine learning algorithm 2303 determines a probability that one or more defects may be displayed in the preprocessed images 2302. In some embodiments, the first machine learning algorithm 2303 employs a One-Class Support Vector Machines (OC-SVM), a Generative Adversarial Network (GAN), a Kernel principal component analysis (KPCA), an autoencoder (AE), a variable autoencoder (VAE), or any combination thereof. OC-SVM may provide novelty detection of rare events according to a probability density. In GAN, two or more neural networks may contest with each other in determination of the output 2306. Given one or more training sets, GAN learns to generate new data with the same statistics as the training set. KPCA may be a multivariate form of principal component analysis (PCA) that uses techniques of kernel methods. PCT may comprise determining a best fitting line that minimizes the average squared distance from a point to the line, given a collection of points in two, three, or higher dimensional space. The AE may be a type of artificial neural network that learns a representation for a set of data, typically for dimensionality reduction, by training the network to ignore signal “noise”. In some embodiments, VAE provides a probabilistic manner for describing an observation in a latent space.

In some embodiments, if the defect is found in the preprocessed images 2302 by the first machine learning algorithm 2303, a second machine algorithm 2304 determines one or more defect types 2305 of the one or more defects found by the first machine learning algorithm 2303. In some embodiments, the second machine learning algorithm 2304 employs segmentation, regression, or both. In some embodiments, the second machine learning algorithm 2304 further determines an output 2306 based on the type of the defect 2305. In some embodiments, the output 2305 may be an indicator added to the image 2301, the preprocessed image 2302, or both, indicating one or more locations of the defect. In some embodiments, the output 2306 may be an instruction to stop the operation of the machine (e.g. circular knitting machine). In some embodiments, the output 2306 may be used to maintain quality control as the roll-to-roll material (e.g. fabric) is being produced by a machine (e.g. a circular knitting machine). In some embodiments, one or more notifications may be sent to business intelligence, quality assurance, or a process monitor based on the output 2306 that one or more defects exists. In some embodiments, the output 2306 comprises a quantity of one or more defects in an image 2301, a quantity of the one or more defects per length of the roll-to-roll material (i.e. fabric), or both. In some embodiments, the unsupervised methods provided herein require less computational power to determine the output based on a set quantity of the images 2301.

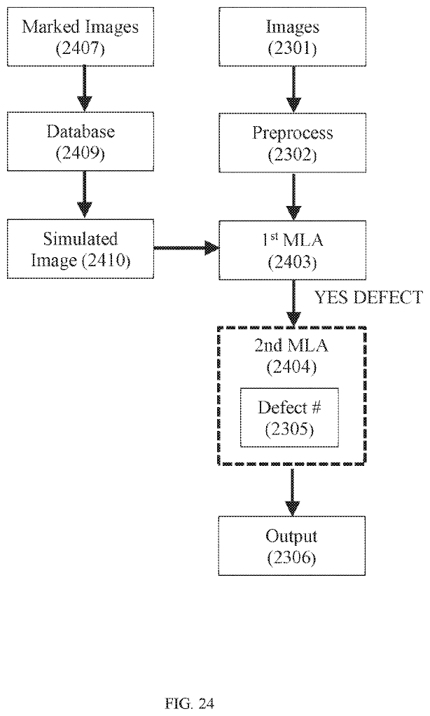

FIG. 24 shows a flowchart of an exemplary supervised method to detect one or more defects in a roll-to-roll material (e.g. fabric) or to maintain quality control during production of the roll-to-roll material. As shown, in some embodiments, the images 2301 may be preprocessed 2302. In some embodiments, the 5, 10, 20, 30, 40, 50, 75, 100, 125, 150, 200, 250, 300, 400, 500, 750, 1,000, 5,000, 10,000 or more images 2301 may be preprocessed 2302. In some embodiments, the images may be obtained from or associated with a machine, for example a CKM. In some embodiments, the preprocessed images may be input into a first machine learning algorithm 2403. In some embodiments, the first machine learning algorithm 2403 determines whether or not one or more defects are displayed in the preprocessed images 2302. In some embodiments, the first machine learning algorithm 2403 determines whether or not one or more defects are displayed in the preprocessed images 2302. In some embodiments, the first machine learning algorithm 2403 employs a Convolutional Neural Network (CNN), a Support Vector Machine, or both. In some embodiments, as shown, the first machine learning algorithm 2403 further receives marked images 2407 from a database 2408.

In some embodiments, the method comprises forming a simulated image 2410. In some embodiments, generating the simulated image 2410 from the marked image 2407 comprises rotating the marked image 2407, translating the marked image 2407, skewing the marked image 2407, modifying a brightness of the marked image 2407, modifying a wavelength of the marked image 2407, modifying a magnification of the marked image 2407, modifying a contrast of the marked image 2407, blurring the marked image 2407, or any combination thereof. In some embodiments, at least one of the one or more simulated images 2410 may be associated with the light source scheme. In some embodiments, the light source scheme may be associated with a lighting condition in a specific factory, in a specific machine, at a specific date, or any combination thereof. In some embodiments, generating the one or more simulated images 2410 from the marked image 2407 enables the use of a greater quantity of training images from those captured, annotated, or both. In some embodiments, generating the one or more simulated images 2410 of the fabric comprises pasting an image of a defect into a marked image 2407 that is copied from an image predetermined as having a defect.

In some embodiments, the first machine learning algorithm 2403 further determines whether or not one or more defects are displayed in the preprocessed images 2302 based on the marked images 2407, the simulated images 2410, or both. In some embodiments, the marked images 2407 comprise an image predetermined as displaying one or more defects, an image predetermined as not displaying one or more defects, or both. In some embodiments, the marked images 2407 comprise an image predetermined as displaying one or more certain defects. In some embodiments, the marked images 2407 comprise an image predetermined based on an input from a technician, an operator, a supervisor, or any combination thereof.

In some embodiments, if the defect is found in the preprocessed images 2302 by the first machine learning algorithm 2403, a second machine algorithm 2404 determines one or more defect types 2305 of the defect found by the first machine learning algorithm 2303. In some embodiments, the second machine learning algorithm 2304 employs segmentation, regression, or both. In some embodiments, the second machine learning algorithm 2304 further determines an output 2306 based on the type of the defect 2305. In some embodiments, the output 2306 comprises a quantity of the one or more defects in an image 2301, a quantity of defects per length of the roll-to-roll material (i.e. fabric), or both. In some embodiments, the output 2305 may be an indicator added to the image 2301, the preprocessed image 2302, or both, indicating one or more locations of the defect. In some embodiments, the output 2306 may be an instruction to stop the operation of the machine (e.g. circular knitting machine). In some embodiments, the output 2306 may be used to maintain quality control as the roll-to-roll material (e.g. fabric) is being produced by a machine (e.g. a circular knitting machine). In some embodiments, one or more notifications may be sent to business intelligence, quality assurance, or a process monitor based on the output 2306 that one or more defects exists. In some embodiments, the supervised methods herein may be capable of determining the output with a higher accuracy, precision or both, given a set number of the images 2301.

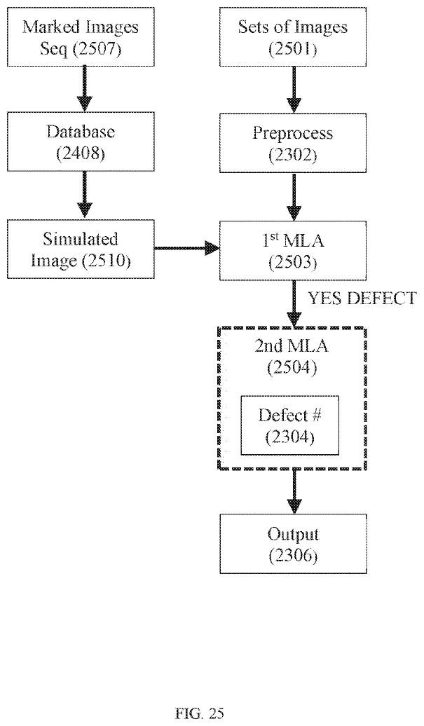

FIG. 25 shows a flowchart of an exemplary clustered method to detect one or more defects in a roll-to-roll material (e.g. fabric) or to maintain quality control during production of the roll-to-roll material. As shown, in some embodiments, the sets or sequences of images 2501 may be preprocessed 2302. In some embodiments, each set of images 2401 comprises 5, 10, 20, 30, 40, 50, 75, 100, 125, 150, 200, 250, 300, 400, 500, 750, 1,000, 5,000, 10,000 or more images. In some embodiments, 5, 10, 20, 30, 40, 50, 75, 100, 125, 150, 200, 250, 300, 400, 500, 750, 1,000, 5,000, 10,000 or more sets of images may be preprocessed 2302. In some embodiments, the images may be obtained from or associated with a machine, for example a CKM. In some embodiments, the preprocessed images may be input into a first machine learning algorithm 2503. In some embodiments, the first machine learning algorithm 2503 determines whether or not one or more defects are displayed in the preprocessed images 2302. In some embodiments, the first machine learning algorithm 2503 employs a Convolutional Neural Network (+CNN), a Long Short-Term Memory (LSTM), a Gated Recurrent Unit (GRU), or any combination thereof. In some embodiments, as shown, the first machine learning algorithm 2503 further receives marked images 2407 from a database 2408.

In some embodiments, the method comprises forming a simulated image 2410. In some embodiments, generating the simulated image 2410 from the marked image 2407 comprises rotating the marked image 2407, translating the marked image 2407, skewing the marked image 2407, modifying a brightness of the marked image 2407, modifying a wavelength of the marked image 2407, modifying a magnification of the marked image 2407, modifying a contrast of the marked image 2407, blurring the image 2407, or any combination thereof. In some embodiments, at least one of the one or more simulated images 2410 may be associated with the light source scheme. In some embodiments, the light source scheme is associated with a lighting condition in a specific factory, in a specific machine, at a specific date, or any combination thereof. In some embodiments, generating the one or more simulated images 2410 from the marked image 2407 enables the use of a greater quantity of training images from those captured, annotated, or both. In some embodiments, generating the one or more simulated images 2410 of the fabric comprises pasting an image of a defect into a image 2407 that is copied from an image predetermined as having a defect.

In some embodiments, the first machine learning algorithm 2503 further determines whether or not one or more defects are displayed in the preprocessed images 2302 based on the marked images 2407, the simulated images 2410, or both. In some embodiments, the marked images 2407 comprise an image predetermined as displaying one or more defects, an image predetermined as not displaying one or more defects, or both. In some embodiments, the marked images 2407 comprise an image predetermined as displaying a certain defect. In some embodiments, the marked images 2407 comprise an image predetermined based on an input from a technician, an operator, a supervisor, or any combination thereof. In some embodiments, if the defect is found in the preprocessed images 2302 by the first machine learning algorithm 2503, a second machine algorithm 2504 determines one or more defect types 2305 of the defect found by the first machine learning algorithm 2303. In some embodiments, the second machine learning algorithm 2304 employs segmentation, regression, or both. In some embodiments, the second machine learning algorithm 2304 further determines an output 2306 based on the one or more types of the defect 2305. In some embodiments, the output 2306 comprises a quantity of defects in an image 2301, a quantity of defects per length of the roll-to-roll material (i.e. fabric), or both. In some embodiments, the output 2305 is an indicator added to the sets of images 2501, the preprocessed image 2302, or both, indicating one or more locations of the defect. In some embodiments, the output 2306 is an instruction to stop the operation of the machine (e.g. circular knitting machine). In some embodiments, the output 2306 may be used to maintain quality control as the roll-to-roll material (e.g. fabric) is being produced by a machine (e.g. a circular knitting machine). In some embodiments, a notification is sent to business intelligence, quality assurance, or a process monitor based on the output 2306 that one or more defects exists.

In some embodiments, the application is further configured to perform: receiving the image of the fabric, applying a third machine learning algorithm to the image to determine a quality of the image; receiving verified data regarding the quality of the image; feeding back the verified data to improve the third machine learning algorithm's calculation over time. In some embodiments, the third machine learning algorithm is trained by: a first training module creating a first training set comprising a plurality of the images, wherein a first portion of the plurality of images may be predetermined as having a sufficient quality, and wherein a second portion of the plurality of images may be predetermined as having an insufficient quality; a first training module training the neural network using the first training set; a second training module creating a second training set for second stage training comprising the first training set and the images in the second plurality of images incorrectly detected as having the sufficient quantity; training the neural network using the second training set. In some embodiments, the plurality of images be predetermined as having an insufficient or a sufficient clarity is determined by a technician, an operator, a supervisor, or any combination thereof. In some embodiments, the third machine learning algorithm is trained by: a first training module creating a first training set comprising a plurality of the images, each image of the plurality of images associated with a quality index; a first training module training the neural network using the first training set; a second training module creating a second training set for second stage training comprising the first training set and the images in the plurality of images whose quality index was incorrectly determined beyond a set quality value; training the neural network using the second training set. In some embodiments, training the neural network using the first training set, using the second training set, or both, comprises training with two or more images simultaneously. The images may be obtained from or associated with a machine, for example a Circular Knitting Machine (CKM)

In some embodiments, the quality index of an image represents a clarity of the image. In some embodiments, the quality index of an image represents a quantity of particulate clouding the image. In some embodiments, the quality index of an image is digitally represented. In some embodiments, the images having a high quality index have improved clarity, reduced debris, or both. In some embodiments, the images having a high quality index have reduced clarity, increased debris, or both. In some embodiments, the quality index of an image determines the image's efficacy in the detection of defects. In some embodiments, the quality index of an image determines the image's efficacy to maintain quality control as the roll-to-roll material (e.g. fabric) is being produced by a machine (e.g. a circular knitting machine). In some In some embodiments, the determination of an image with a low quality index alerts an operator to clean the camera of debris. In some embodiments, the quality index binarily represents an image of acceptable quality or an image of unacceptable quality. In some embodiments, a low quality index and/or an unacceptable quality index is caused by debris from the factory obscuring at least a portion of the camera. In some embodiments, a low quality index and/or an unacceptable quality index reduces and/or eliminates the ability of the machine learning methods herein to determine the presence and/or type of the defect. As such, ensuring that the captured images may be acceptable and/or have a quality index above a certain value enables continued defect detection and/or determination in real-time and/or at high accuracy rates. Further ensuring that the captured images may be acceptable and/or have a quality index above a certain value enables quality control as the roll-to-roll material (e.g. fabric) is being produced by a machine (e.g. a circular knitting machine).

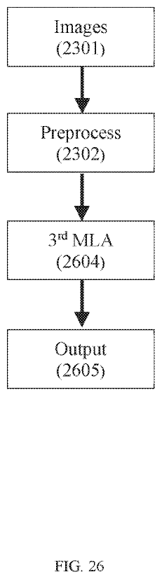

FIG. 26 shows a flowchart of an exemplary method to detect a quality index of an image to maintain quality control during production of the roll-to-roll material (e.g. fabric). As shown, the method comprises a third machine learning algorithm 2604 receiving images 2301 that have been preprocessed 2302. In some embodiments, the third machine learning algorithm 2604 determines an output 2605. In some embodiments, the output 2605 is a quality index of the images 2301, the preprocessed images 2302, or both. In some embodiments, the output 2305 is a notification to an operator to clean the camera of debris. In some embodiments, the method to detect a quality index of an image to maintain quality control during production of the roll-to-roll material (e.g. fabric) can be used in conjunction with any other methods, systems, or media described herein.

In some embodiments, the first machine learning algorithm, the second machine learning algorithm and the third machine learning algorithm may be performed in any order. In some embodiments, the first machine learning algorithm is performed before the second machine learning algorithm, the third machine learning algorithm, or both. In some embodiments, the second machine learning algorithm is performed before the first machine learning algorithm, the third machine learning algorithm, or both. In some embodiments, the third machine learning algorithm is performed before the first machine learning algorithm, the second machine learning algorithm, or both. In some embodiments, the method does not comprise feeding back the verified data to improve the first machine learning algorithm's calculation over time. In some embodiments, the method does not comprise feeding back the verified data to improve the second machine learning algorithm's calculation over time. In some embodiments, the method does not comprise feeding back the verified data to improve the third machine learning algorithm's calculation over time.

In some embodiments, the systems, methods, and media herein can be implemented using the systems described in any one of: PCT Application No. PCT/PT2020/050003; PCT Application No. PCT/PT2020/050012; PCT Application No. PCT/PT2020/050013; and PCT Application No. PCT/PT2020/050020.

### Machine Learning Algorithms

In some embodiments, machine learning algorithms may be utilized to aid in determining that one or more defects exists in a roll-to-roll material (e.g. fabric) and/or maintaining quality control as the roll-to-roll material (e.g. fabric) is produced. In some embodiments, machine learning algorithms may be utilized to aid in determining a type of defect that exists in a roll-to-roll material (e.g. fabric). In some embodiments, machine learning algorithms may be utilized to aid in forming simulated images.

In some embodiments, the machine learning algorithms employ one or more forms of labels including but not limited to human annotated labels and semi-supervised labels. The human annotated labels may be provided by a hand-crafted heuristic. For example, the hand-crafted heuristic may comprise providing the determined defect. The semi-supervised labels may be determined using a clustering technique to find images similar to those flagged by previous human annotated labels and previous semi-supervised labels. The semi-supervised labels may employ a XGBoost, a neural network, or both.

In some embodiments, the classificational supervised machine learning algorithms are employed to determine a quantitative defect of the roll-to-roll material (e.g. fabric). In some embodiments, regression supervised machine learning algorithms are employed to determine a qualitative defect of the roll-to-roll material (e.g. fabric). In some embodiments, the machine learning algorithms herein are non-supervised. In some embodiments, the non-supervised machine learning algorithms are employed to determine a qualitative defect of the roll-to-roll material (e.g. fabric). In some embodiments, the methods, systems, and media herein employ two or more machine learning algorithms. In some embodiments, the defect comprises a quantitative defect and a qualitative defect wherein supervised and unsupervised machine learning algorithms are employed. In some embodiments, the defect comprises a quantitative defect and a qualitative defect wherein classificational and regression supervised machine learning algorithms are employed.

In some embodiments, the machine learning algorithms herein may be trained with a distant supervision method. The distant supervision method may create a large training set seeded by a small hand-annotated training set. The distant supervision method may comprise positive-unlabeled learning with the training set as the ‘positive’ class. The distant supervision method may employ a logistic regression model, a recurrent neural network, or both. The recurrent neural network may be advantageous for Natural Language Processing (NLP) machine learning.

Examples of machine learning algorithms may include a support vector machine (SVM), a naïve Bayes classification, a random forest, a neural network, deep learning, or other supervised learning algorithm or unsupervised learning algorithm for classification and regression. The machine learning algorithms may be trained using one or more training datasets.

In some embodiments, the machine learning algorithm utilizes regression modeling, wherein relationships between predictor variables and dependent variables may be determined and weighted. In one embodiment, for example, one or more defects type may be a dependent variable and is derived from the images within the data set.

In some embodiments, a machine learning algorithm is used to select catalogue images and recommend project scope. A non-limiting example of a multi-variate linear regression model algorithm is seen below: probability=A0+A1(X1)+A2(X2)+A3(X3)+A4(X4)+A5(X5)+A6(X6)+A7(X7) . . . wherein Ai (A1, A2, A3, A4, A5, A6, A7, . . . ) may be “weights” or coefficients found during the regression modeling; and Xi (X1, X2, X3, X4, X5, X6, X7, . . . ) may be data collected from the User. Any number of Ai and Xi variable may be included in the model. For example, in a non-limiting example wherein there may be 7 Xi terms, X1 is the number of images, X2 is the number of imaging showing one or more defects, and X3 is the defect type. In some embodiments, the programming language “R” is used to run the model.]

In some embodiments, training comprises multiple steps. In a first step, an initial model is constructed by assigning probability weights to predictor variables. In a second step, the initial model is used to “recommend” defects. In a third step, the validation module accepts verified data regarding the type or existence of defects and feeds back the verified data to the renovation probability calculation. At least one of the first step, the second step, and the third step may repeat one or more times continuously or at set intervals.

### Defects

In some embodiments, the roll-to-roll material comprises a textile, a metal or metal alloy, a paper, or a plastic, or a wood. In some embodiments, the roll-to-roll material comprises a textile, wherein the defect comprises a hole defect, a needle defect, a lycra defect, a lycra dashed defect, a yarn thickness defect, a yarn color defect, a double yarn defect, a periodicity defect, a needle defect, a pattern periodicity defect, a color periodicity defect, a transition defect, a transition defect, a barriness defect, a streakiness defect, a snarl defect, a contaminations defect, a spirality defect, a sinker lines defect, a surface hairiness & piling defect, a bowing defect, a or any combination thereof.

In some embodiments, the roll-to-roll material comprises a metal or metal alloy wherein the defect comprises a hole defect, a wrinkle defect, a tear defect, a divot defect, a crack defect, a thinning defect, a porosity defect, a piping defect, an inclusion defect, or any combination thereof. In some embodiments, the roll-to-roll material comprises a paper wherein the defect comprises a hole defect, a wrinkle, a tear, a discoloration, a surface texture defect, a flocculation defect, a macro forming defect, an unstable streak defect, a periodic variation defect, a random variation defect, or any combination thereof. In some embodiments, the roll-to-roll material comprises a plastic wherein the defect comprises a hole defect, a wrinkle defect, a tear defect, a divot defect, a discoloration defect, a surface texture defect, a gel defect, a coating void defect, a die line defect, or any combination thereof. In some embodiments, the roll-to-roll material comprises a wood wherein the defect comprises a bark defect, a clear wood defect, a colored streaks defect, a curly grain defect, a discoloration defect, a holes defect, a pin knots defect, a rotten knots defect, a roughness defect, a sound knots defect, a splits defect, a streaks defect, a worm holes defect, or any combination thereof.

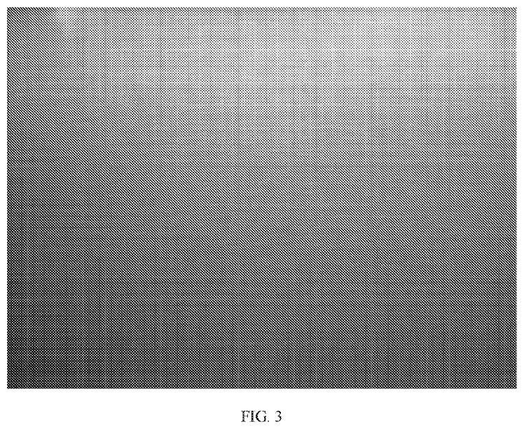

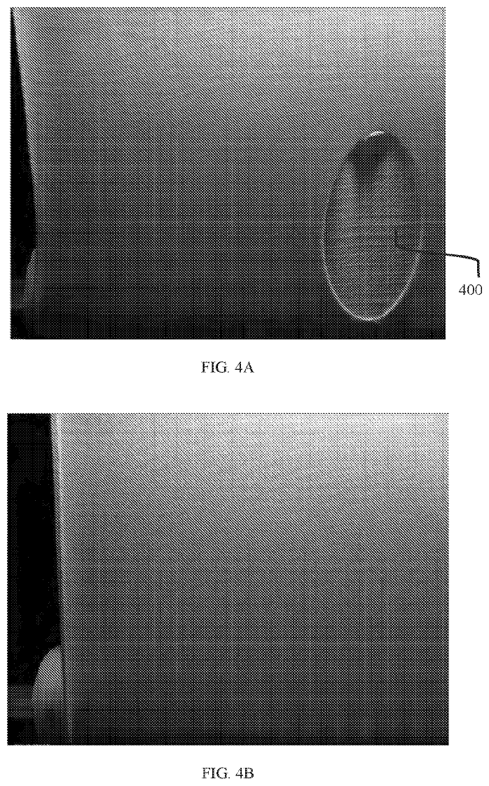

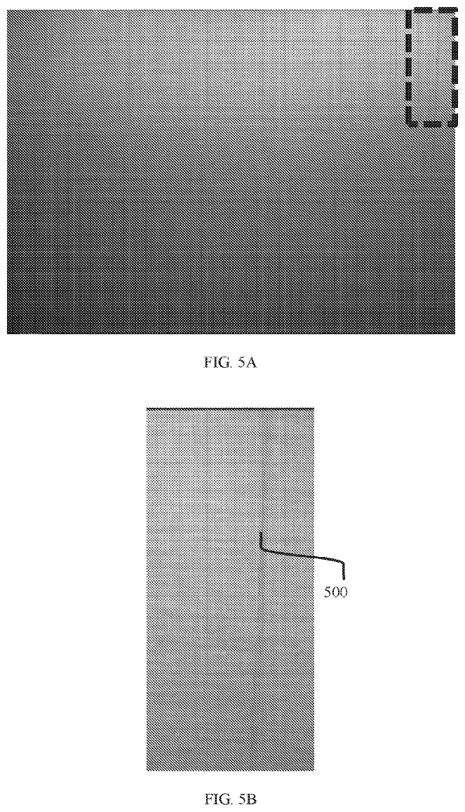

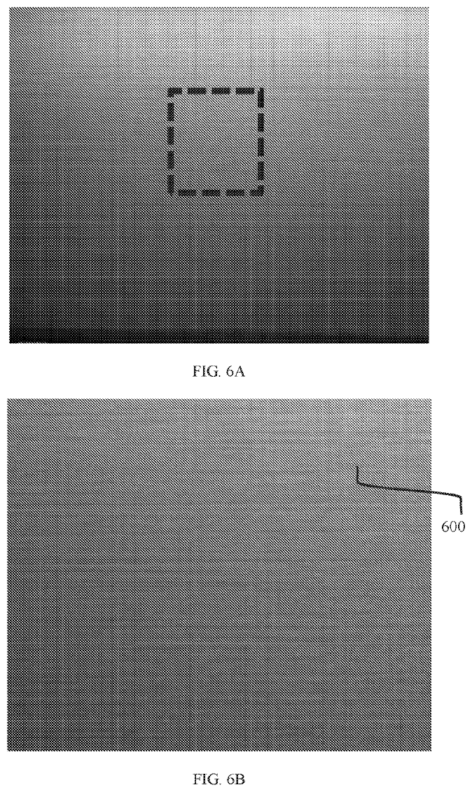

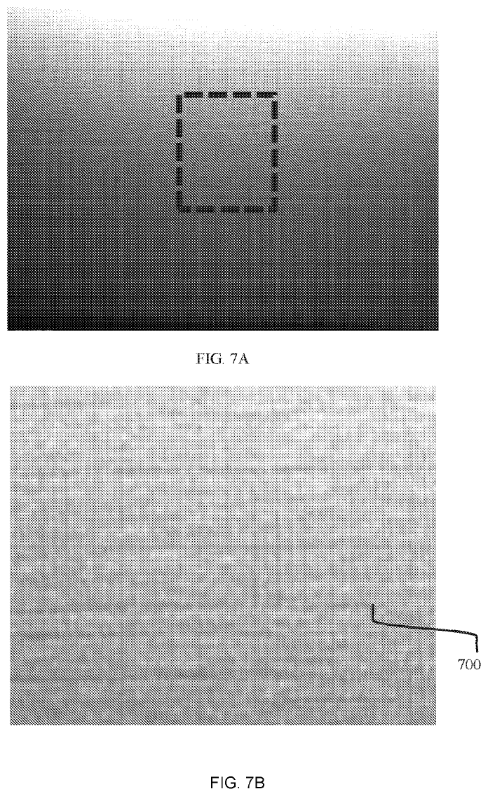

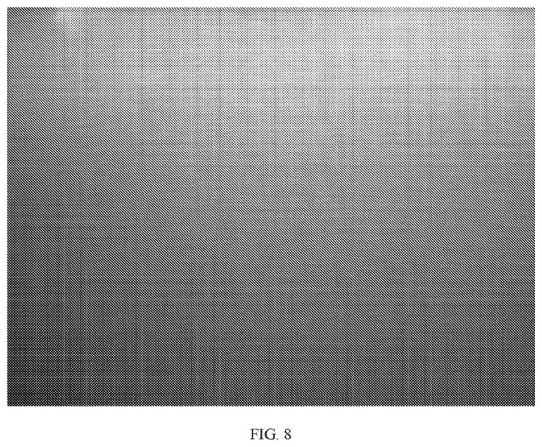

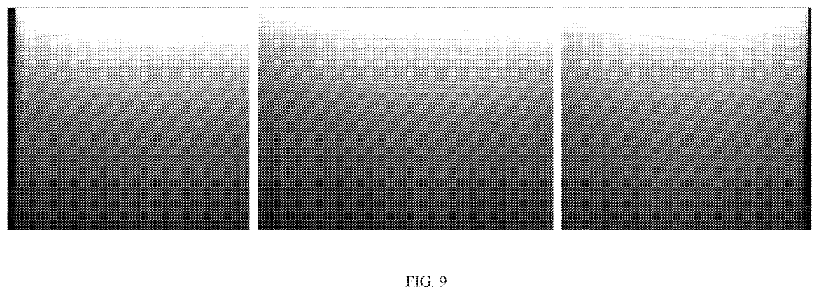

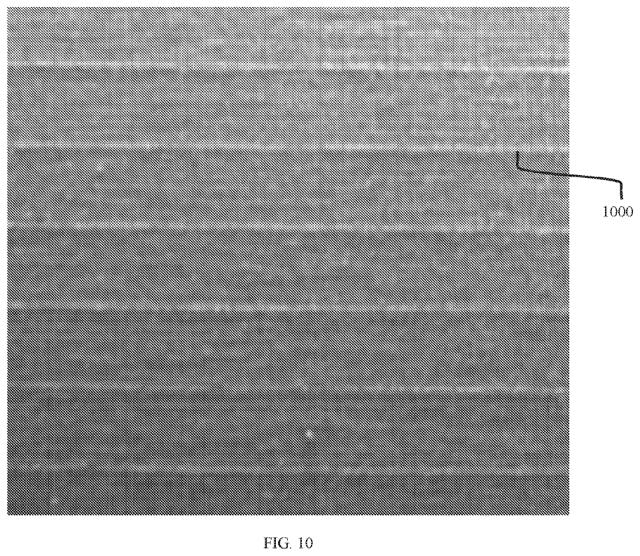

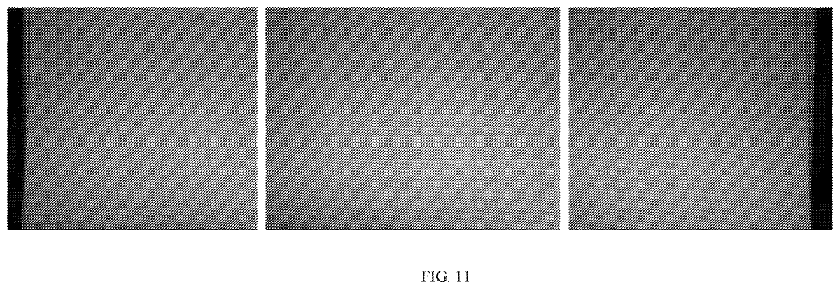

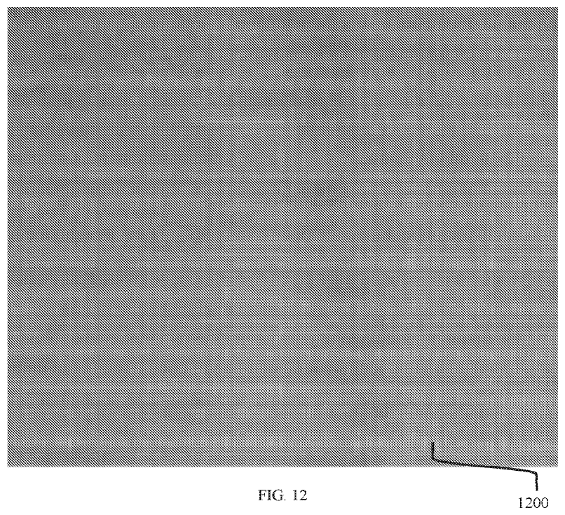

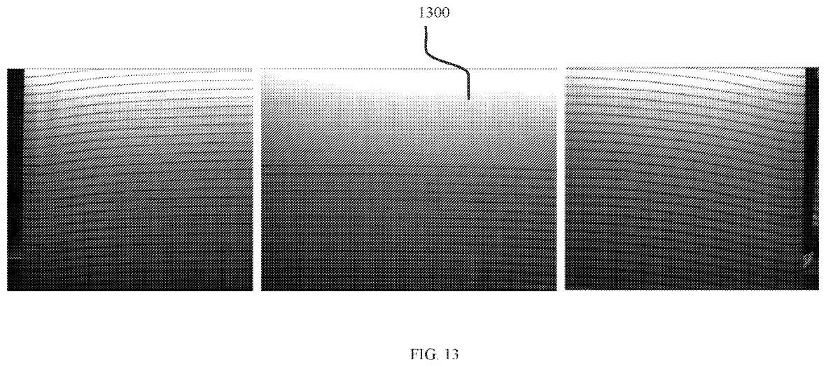

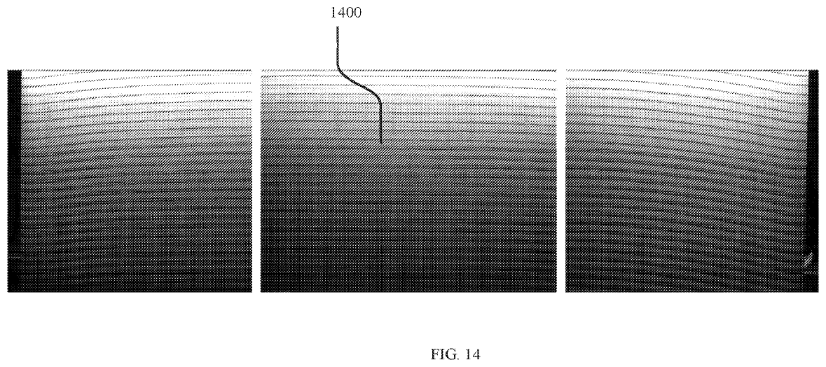

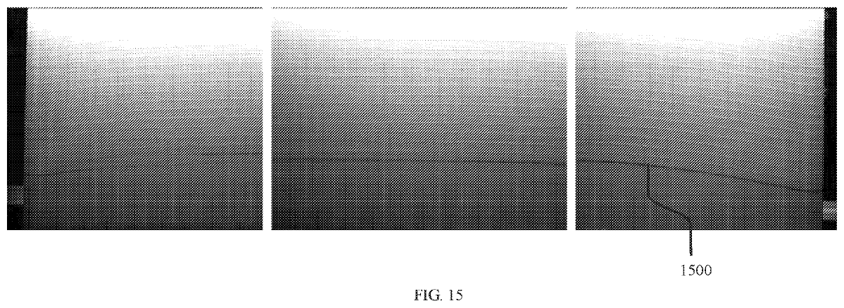

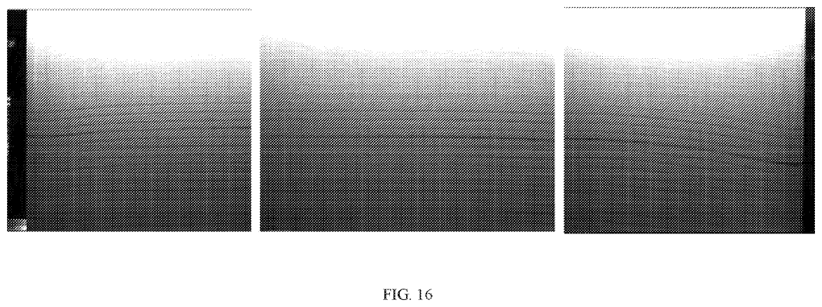

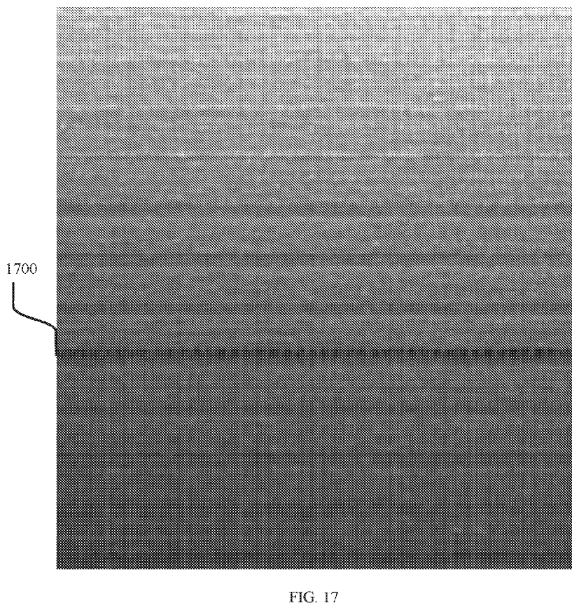

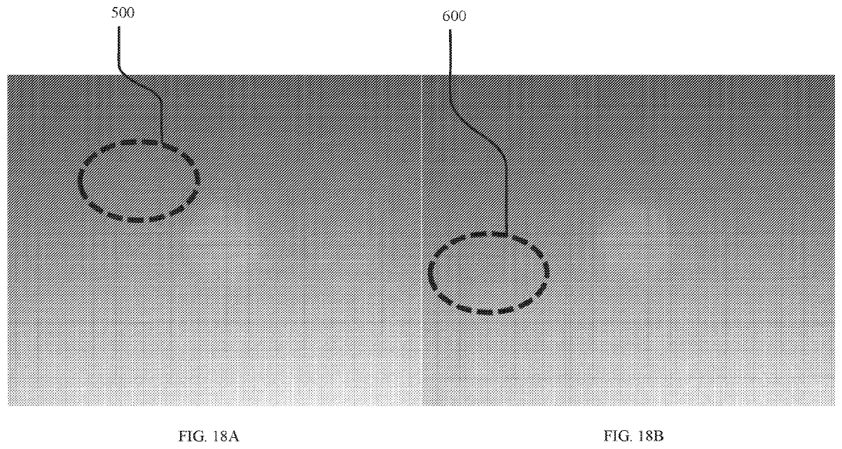

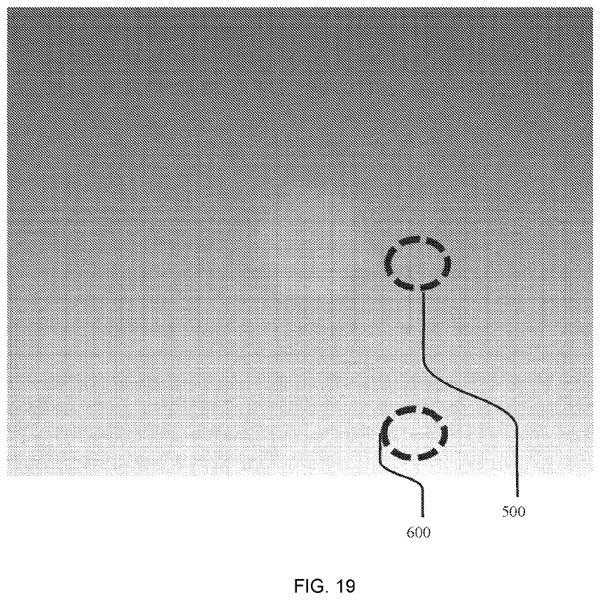

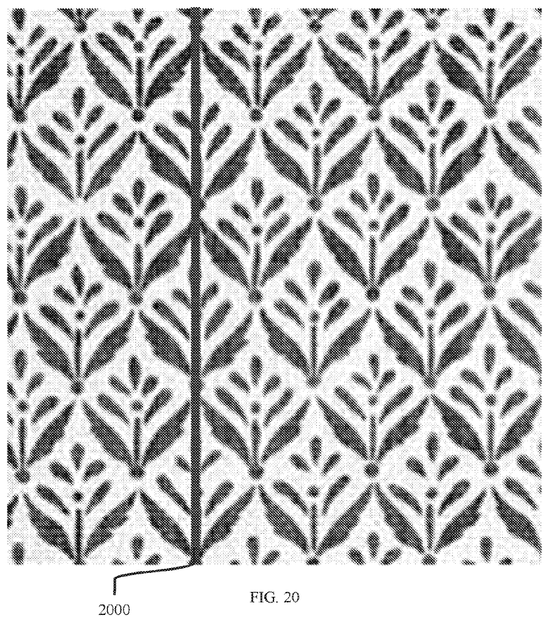

FIG. 3 shows an image of an exemplary defect-free jersey textile. FIG. 4A shows an image of an exemplary denim textile with a hole defect 400. The hole defect may comprise a hole through a roll-to-roll material (e.g. fabric), when one is not intended. FIG. 4B shows an image of an exemplary defect-free denim textile. FIG. 5A shows an image of an exemplary textile with a needle defect 500. FIG. 5B shows a high magnification image of the exemplary needle defect 500 of FIG. 5A. FIG. 6A shows an image of an exemplary textile with a lycra defect 600. In some embodiments, the lycra defect 600 comprises a defect in a continuous elastane product. FIG. 6B shows a high magnification image of the exemplary lycra defect 600 of FIG. 6A. FIG. 7A shows an image of an exemplary textile with a lycra-dash defect 700. In some embodiments, the lycra-dash defect 700 comprises a dashed defect in a continuous elastane product. FIG. 7B shows a high magnification image of the exemplary lycra-dash defect 700 of FIG. 7A. FIG. 8 shows am image of an exemplary defect-free textile. FIG. 9 shows a image of an exemplary textile having a thick yarn defect. The thick yarn defect may comprise a portion of the roll-to-roll material (e.g. fabric) wherein at least a portion of the yarn is thicker than the surrounding yarn, when one is not intended. FIG. 10 shows a high magnification image of the exemplary thick yarn defect 1000 of FIG. 9. FIG. 11 shows a image of an exemplary textile having a thin yarn defect. The thin yarn defect may comprise a portion of the roll-to-roll material (e.g. fabric) wherein at least a portion of the yarn is thin than the surrounding yarn, when one is not intended. FIG. 12 shows a high magnification image of the exemplary thin yarn defect 1200 of FIG. 11. FIG. 13 shows a image of an exemplary textile having a color periodicity defect 1300. In some embodiments, a transition defect occurs during a transition between the production of different patterns. For example, when the pattern transitions from a periodic line pattern to a 2 periodic line pattern or a no periodic line pattern. FIG. 14 shows a image of an exemplary textile having a double yarn defect 1400. The double yarn defect may comprise a portion of the roll-to-roll material (e.g. fabric) wherein at least a portion of the fabric comprises two or more pieces of yarn, when such a feature is not intended. FIG. 15 shows a first image of an exemplary textile having a transition defect 1500. FIG. 16 shows a second image of an exemplary textile having a transition defect. FIG. 17 shows a high magnification image of the exemplary transition defect 1700 of FIG. 16. FIG. 18A shows an image of an exemplary textile having a needle defect 500. FIG. 18B shows an image of an exemplary textile having a lycra defect 600 and a lycra-dash defect 700. FIG. 19 shows an image of an exemplary textile having a needle defect 500 and lycra defects 600. FIG. 20 shows an image of an exemplary textile having a pattern periodicity defect 1900. The pattern periodicity defect may comprise a portion of the roll-to-roll material (e.g. fabric) wherein one or more pattern elements are disfigured and/or different than other patterned elements, when such a feature is not intended.

In some embodiments, a defect in the formation of one type of roll-to-roll material (e.g. fabric) is considered a feature and not a defect in the formation of another type of roll-to-roll material (e.g. fabric). In some embodiments, no notification is sent and/or no process is interrupted if the determined defect is of a type that is acceptable and/or inherent to the formation of a roll-to-roll material (e.g. fabric).

In some embodiments, the computer-implemented methods, non-transitory computer-readable storage media and computer-implemented systems is further integrated with the process control hardware or software to enable improved process control. The computer-implemented methods, non-transitory computer-readable storage media and computer-implemented systems herein may be capable of recognizing regular or repeating defects or regular substandard roll-to-roll materials or products that may evidence a broken or malfunctioning manufacturing device. The computer-implemented methods, non-transitory computer-readable storage media and computer-implemented systems may be configured to alert a human operator or automatically stop a manufacturing process if a defect detection rate exceeds a threshold level or a quality control standard falls below a threshold level. In some embodiments, the computer-implemented methods, non-transitory computer-readable storage media and computer-implemented systems may be capable of providing process information and warnings regarding defects or substandard roll-to-roll materials or products to a human operator. In some embodiments, the computer-implemented methods, non-transitory computer-readable storage media and computer-implemented systems provide control functions to a human operator that allow intervention in the case of a malfunctioning machine.

Defects on a roll-to-roll material or product surface or body may have a characteristic behavior in the presence of a light source. For example, holes, tears, blockages, or occlusions may all be characterized by changes in the transmission of light. In another examples, surface flaws such as pits or bulges may be detected by changes in the reflection or scattering patterns of an impinging light source. Substandard roll-to-roll materials may be measured by bulk parameters or may be assessed by other measures such as statistical analysis of detected defects.

Roll-to-roll materials or products produced from a manufacturing process may contain defects or may be substandard roll-to-roll materials or products. Defects or substandard roll-to-roll materials or products may arise from the raw roll-to-roll materials used to create the roll-to-roll material or product. For example, flaws in yarn used in a textile manufacturing process may create defects in a produced roll-to-roll material (e.g. fabric) where the yarn flaws may be incorporated. Defect or substandard roll-to-roll materials or products may arise from the equipment used to manufacture the roll-to-roll material or product. For example, a broken or damaged needle in a knitting machine may regularly or irregularly incorporate defects into a roll-to-roll material (e.g. fabric). Defects or substandard roll-to-roll materials or products may arise from the process used to manufacture the roll-to-roll material or product. For example, an unexpected shift in processing conditions (e.g., an ambient humidity level) may alter or otherwise affect the finished product from a manufacturing process. Defects or substandard roll-to-roll materials or products may arise inherently during the production of roll-to-roll materials or products, or may occur due to unplanned circumstances such as malfunctioning manufacturing machinery or compromised raw roll-to-roll materials for production. Defects or substandard roll-to-roll materials or products may arise from a human error, including improper construction of manufacturing devices, improper setup and installation of manufacturing devices, improper initialization of manufacturing devices, improper operation of manufacturing devices, and improper programming of software or other control systems. Human errors may further include failure to detect defects or substandard roll-to-roll materials or products due to inexperience, fatigue, oversight, or other issues relating to manual visual or physical inspection

Defects may be deemed to be minor or major defects. A minor defect may comprise a defect that does not render a roll-to-roll material or product unusable or unsellable. A major defect may comprise a defect that renders a roll-to-roll material or product unusable, unsellable, or otherwise compromises the properties of the product. In some cases, a plurality of minor defects may comprise a major defect if the additive effect of the plurality of minor defects renders the roll-to-roll material or product unusable, unsellable, or otherwise compromises the properties of the product. Substandard roll-to-roll materials or products may be downgraded to a lower grade of roll-to-roll material or product. In some cases, a substandard roll-to-roll material or product may be unusable, unsellable, or otherwise compromised. An optical detection system may be capable of identifying major defects, minor defects, or substandard roll-to-roll materials or products.

Defects in a roll-to-roll material or product may occur at a characterizable rate. In some cases, defects in a roll-to-roll material or product may occur randomly. In other cases, defects in a roll-to-roll material or product may occur regularly. The rate of occurrence for defects may differ based upon the stage or step in manufacture of a roll-to-roll material or product. Defects may be known to occur at differing rates during transient phases of a manufacturing process such as start-up, stopping, or changing of process feeds.

The rate of occurrence of defects or substandard roll-to-roll materials or products may be correlated to a roll-to-roll material or product processing parameter. For example, defects or substandard roll-to-roll materials or products may occur at a known rate per time, at a known rate per area of roll-to-roll material produced, at a known rate per volume of roll-to-roll material produced, at a known rate per length of roll-to-roll material produced, or at a known rate per weight of roll-to-roll material produced. Minor defects and major defects may occur at differing rates. In some cases, a threshold rate of defect occurrence may occur at which a roll-to-roll material or product is considered unusable, unsellable or otherwise compromised.

Optical detection systems may be utilized to identify defects or substandard quality in roll-to-roll materials or products. Optical detection systems may be utilized to determine the defect rate or quality level of roll-to-roll materials or products during a manufacturing process. An optical detection system may be capable of identifying a plurality of types of defects or quality levels. An optical detection system may be capable of identifying minor defects and major defects or substandard roll-to-roll materials or products in a produced roll-to-roll material or product. An optical detection system may be capable of quantifying a rate of occurrence for minor and/or major defects or substandard roll-to-roll materials or products during the production of a roll-to-roll material or product.

Defects in manufactured roll-to-roll materials or products may include any damage or irregularity in the form or structure of the roll-to-roll material or product. Defects may occur at any length scale from microscale to macroscale. A defect may be characterized by a characteristic size such as a defect length, defect width, defect depth, defect thickness, defect diameter, defect area, or defect volume. Defects in roll-to-roll materials may include holes, cracks, fractures, pits, pores, depressions, tears, burns, stains, bends, breaks, domains of thinning, domains of thickening, stretches, compressions, bulges, deformations, discontinuities, missing substituents, blockages, occlusions, or unwanted inclusions.

A defect may have a characteristic dimension associated with it. An optical detection system may be capable of identifying a defect at a given length scale. A defect may have an average dimension (e.g., length, width, depth, thickness, diameter) of about 100 nanometers (nm), 500 nm, 1 micrometer (μm), 5 μm, 10 μm, 25 μm, 50 μm, 100 μm, 200 μm, 250 μm, 500 μm, 750 μm, 1 mm, 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more than 10 cm. A defect may have an average dimension (e.g., length, width, depth, thickness, diameter) of at least about 100 nanometers (nm), 500 nm, 1 micrometer (um), 5 μm, 10 μm, 25 μm, 50 μm, 100 μm, 200 μm, 250 μm, 500 μm, 750 μm, 1 mm, 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more than 10 cm. A defect may have an average dimension (e.g., length, width, depth, thickness, diameter) of no more than about 10 cm, 9 cm, 8 cm, 7 cm, 6 cm, 5 cm, 4 cm, 3 cm, 2 cm, 1 cm, 9 mm, 8 mm, 7 mm, 6 mm, 5 mm, 4 mm, 3 mm, 2 mm, 1 mm, 750 μm, 500 μm, 250 μm, 200 μm, 100 μm, 50 μm, 25 μm, 10 μm, 5 μm, 1 μm, 500 nm, 100 nm, or less than 100 nm. A defect may have a characteristic average area of at least about 0.01 μm2, 0.1 μm2, 1 μm2, 10 μm2, 100 μm2, 1000 μm2, 10000 μm2, 100000 μm2, 1 mm2, 10 mm2, 1 cm2, 10 cm2, 100 cm2, or more than about 100 cm2. A defect may have a characteristic average area of no more than about 100 cm2, 10 cm2, 1 cm2, 10 mm2, 1 mm2, 100000 μm2, 10000 μm2, 1000 μm2, 100 μm2, 10 μm2, 1 μm2, 0.1 μm2, 0.01 μm2, or less than about 0.01 μm2.

Defects may occur in a roll-to-roll material or product at regular or irregular intervals. Defects may occur with a particular number density. For example, a roll-to-roll material or product may have a rate of defects per unit length (μm, mm, cm, m, etc.), per unit area (μm2, mm2, cm2, m2, etc.), per unit volume (μm3, mm3, cm3, m3, etc.), or per unit weight (kg, lb, ton, metric ton, etc.). In some roll-to-roll materials or products, defects may be expected to occur at or below a particular number density. In some manufacturing processes, a roll-to-roll material or product may be discarded if the defect rate exceeds a threshold number density. A roll-to-roll material or product may have a defect rate with a number density (e.g., defects per unit length, defects per unit area, defects per unit volume, or defects per unit weight) of about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, 600, 700, 800, 900, 1000 or more than 1000. A roll-to-roll material or product may have a defect rate with a number density of at least about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, 600, 700, 800, 900, 1000 or more than about 1000. A roll-to-roll material or product may have a defect rate with a number density of no more than about 1000, 900, 800, 700, 600, 500, 400, 300, 200, 190, 180, 170, 160, 150, 140, 130, 120, 110, 100, 95, 90, 85, 80, 75, 70, 65, 60, 55, 50, 45, 40, 35, 30, 25, 20, 15, 10, 9, 8, 7, 6, 5, 4, 3, 2, 1 or less than about 1. An optical detection system may quantify the number density of defects in a manufactured roll-to-roll material or product.

In some embodiments, the defect comprises a complete needle defect, an incomplete needle defect, a contamination defect, a needle and sinker defect, a continuous elastane defect (e.g. lycra defect), a dashed elastane defect (e.g. dashed lycra defect), a fiber contamination defect, a color contamination defect, unwanted hairiness defect, a non-uniform column width defect, a non-uniform column width defect, or any combination thereof. In some embodiments, a complete defect occurs when he needle does not pull the yarn. In some embodiments, a contamination defect is caused by oil or solvent leakage. In some embodiments, an incomplete needle defect is caused when needle incorrectly pulls the yarn. In some embodiments, a sinker defects is caused by incorrect combination between sinker and needle. In some embodiments, contamination by other colors occurs when fibers from other sources imprudently get in the production causing spots with different colors.

In some embodiments, the defect comprises a quantitative defect. In some embodiments, the quantitative defect is a quantitative property. In some embodiments, the quantitative quality defect is a defect in a weight quantity, a quantitative color, thread quantity, a thickness measurement, a uniformity measurement, smoothness measurement, a contaminant detection, or any combination thereof.

In some embodiments, the quality defect is qualitative. In some embodiments, the qualitative defect is a defect in a weight qualitative, a color qualitative, a thread qualitative, a thickness qualitative, uniformity quality, a smoothness quality, or any combination thereof. In some embodiments, the qualitative defect is a defect in quality compared with a known benchmark material.

### Roll-to-Roll Materials

The methods, systems, and media herein apply to the inspection of such roll-to-roll materials and products as, for example, textiles (e.g. natural or synthetic fabrics), structural roll-to-roll materials (e.g. sheet metals), piping roll-to-roll materials, wood products, paper products, ceramics, composites, and plastics.

In some embodiments, the textile type comprises canvas, cashmere, chenille, chiffon, cotton, crepe, damask, georgette, gingham, jersey, lace, leather, linen, merino wool, modal, muslin, organza, polyester, satin, silk, spandex, suede, taffeta, toile, tweed, twill, velvet, viscose, or any combination thereof.

In some cases, manufactured textiles such as roll-to-roll material (e.g. fabric)s may be characterized by a particular thread count. A thread count may be defined as the number of horizontal and vertical threads per square inch of the textile roll-to-roll material. A textile may have a thread count of about 50, 100, 150, 200, 250, 300, 350, 400, 450, 500, 550, 600, 650, 700, 750, 800, 850, 900, 950, 1000, or more than about 1000. A textile may have a thread count of at least about 50, 100, 150, 200, 250, 300, 350, 400, 450, 500, 550, 600, 650, 700, 750, 800, 850, 900, 950, 1000, or more than about 1000. A textile may have a thread count of no more than about 1000, 950, 900, 850, 800, 750, 700, 650, 600, 550, 500, 450, 400, 350, 300, 250, 200, 150, 100, 50 or less than about 50.

Roll-to-roll materials or products may be opaque, transparent, reflective, non-reflective, or translucent. The transparency or opacity of a roll-to-roll material or product may vary depending upon the wavelength of light impinging upon the surface of the roll-to-roll material or product. In some cases, a roll-to-roll material may have a characteristic transparency or opacity. The transparency or opacity may be uniform throughout the roll-to-roll material or may vary in a regular or irregular manner. Transparency or transmittance may be defined as the total amount of light that passes through a roll-to-roll material. A roll-to-roll material monitored by an optical detection system may have a characteristic average transmittance of about 99.9%, 99%, 95%, 90%, 85%, 80%, 75%, 70%, 65%, 60%, 55%, 50%, 45%, 40%, 35%, 30%, 25%, 20%, 15%, 10%, 5% or less than about 5%. A roll-to-roll material monitored by an optical detection system may have a characteristic average transmittance of at least about 99.9%, 99%, 95%, 90%, 85%, 80%, 75%, 70%, 65%, 60%, 55%, 50%, 45%, 40%, 35%, 30%, 25%, 20%, 15%, 10%, 5% or less than about 5%. A roll-to-roll material monitored by an optical detection system may have a characteristic average transmittance of at least about 5%, 99%, 10%, 15%, 20%, 25%, 30%, 35%, 40%, 45%, 50%, 55%, 60%, 65%, 70%, 75%, 80%, 85%, 90%, 95%, 99% or more than 99.9%.

### Computer Systems

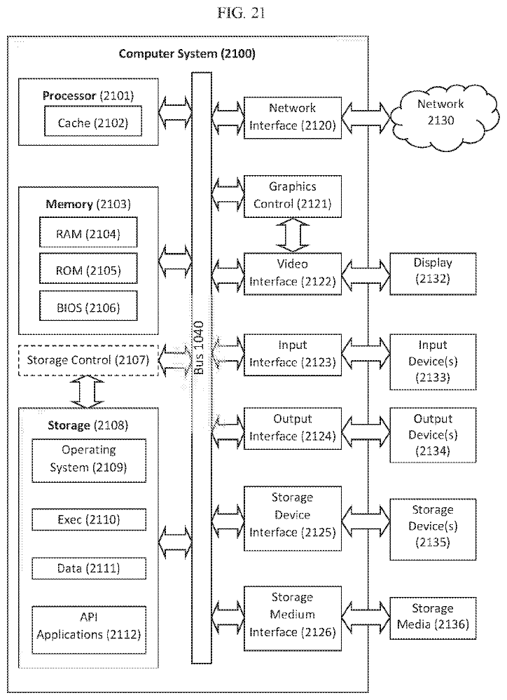

Referring to FIG. 21, a block diagram is shown depicting an exemplary machine that includes a computer system 2100 (e.g., a processing or computing system) within which a set of instructions can execute for causing a device to perform or execute any one or more of the aspects and/or methodologies for static code scheduling of the present disclosure. The components in FIG. 21 are examples only and do not limit the scope of use or functionality of any hardware, software, embedded logic component, or a combination of two or more such components implementing particular embodiments.

The computer system 2100 may include one or more processors 2101, a memory 2103, and a storage 2108 that communicate with each other, and with other components, via a bus 2140. The bus 2140 may also link a display 2132, one or more input devices 2133 (which may, for example, include a keypad, a keyboard, a mouse, a stylus, etc.), one or more output devices 2134, one or more storage devices 2135, and various tangible storage media 2136. All of these elements may interface directly or via one or more interfaces or adaptors to the bus 2140. For instance, the various tangible storage media 2136 can interface with the bus 2140 via storage medium interface 2126. Computer system 2100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 2100 includes one or more processor(s) 2101 (e.g., central processing units (CPUs) or general purpose graphics processing units (GPGPUs)) that carry out functions. Processor(s) 2101 optionally contains a cache memory unit 2102 for temporary local storage of instructions, data, or computer addresses. Processor(s) 2101 are configured to assist in execution of computer readable instructions. Computer system 2100 may provide functionality for the components depicted in FIG. 21 as a result of the processor(s) 2101 executing non-transitory, processor-executable instructions embodied in one or more tangible computer-readable storage media, such as memory 2103, storage 2108, storage devices 2135, and/or storage medium 2136. The computer-readable media may store software that implements particular embodiments, and processor(s) 2101 may execute the software. Memory 2103 may read the software from one or more other computer-readable media (such as mass storage device(s) 2135, 2136) or from one or more other sources through a suitable interface, such as network interface 2120. The software may cause processor(s) 2101 to carry out one or more processes or one or more steps of one or more processes described or illustrated herein. Carrying out such processes or steps may include defining data structures stored in memory 2103 and modifying the data structures as directed by the software.

The memory 2103 may include various components (e.g., machine readable media) including, but not limited to, a random access memory component (e.g., RAM 2104) (e.g., static RAM (SRAM), dynamic RAM (DRAM), ferroelectric random access memory (FRAM), phase-change random access memory (PRAM), etc.), a read-only memory component (e.g., ROM 2105), and any combinations thereof. ROM 2105 may act to communicate data and instructions unidirectionally to processor(s) 2101, and RAM 2104 may act to communicate data and instructions bidirectionally with processor(s) 2101. ROM 2105 and RAM 2104 may include any suitable tangible computer-readable media described below. In one example, a basic input/output system 2106 (BIOS), including basic routines that help to transfer information between elements within computer system 2100, such as during start-up, may be stored in the memory 2103.

Fixed storage 2108 is connected bidirectionally to processor(s) 2101, optionally through storage control unit 2107. Fixed storage 2108 provides additional data storage capacity and may also include any suitable tangible computer-readable media described herein. Storage 2108 may be used to store operating system 2109, executable(s) 2110, data 2111, applications 2112 (application programs), and the like. Storage 2108 can also include an optical disk drive, a solid-state memory device (e.g., flash-based systems), or a combination of any of the above. Information in storage 2108 may, in appropriate cases, be incorporated as virtual memory in memory 2103.

In one example, storage device(s) 2135 may be removably interfaced with computer system 2100 (e.g., via an external port connector (not shown)) via a storage device interface 2125. Particularly, storage device(s) 2135 and an associated machine-readable medium may provide non-volatile and/or volatile storage of machine-readable instructions, data structures, program modules, and/or other data for the computer system 2100. In one example, software may reside, completely or partially, within a machine-readable medium on storage device(s) 2135. In another example, software may reside, completely or partially, within processor(s) 2101.

Bus 2140 connects a wide variety of subsystems. Herein, reference to a bus may encompass one or more digital signal lines serving a common function, where appropriate. Bus 2140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 2100 may also include an input device 2133. In one example, a user of computer system 2100 may enter commands and/or other information into computer system 2100 via input device(s) 2133. Examples of an input device(s) 2133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 2133 may be interfaced to bus 2140 via any of a variety of input interfaces 2123 (e.g., input interface 2123) including, but not limited to, serial, parallel, game port, USB, FIREWIRE, THUNDERBOLT, or any combination of the above.

In particular embodiments, when computer system 2100 is connected to network 2130, computer system 2100 may communicate with other devices, specifically mobile devices and enterprise systems, distributed computing systems, cloud storage systems, cloud computing systems, and the like, connected to network 2130. Communications to and from computer system 2100 may be sent through network interface 2120. For example, network interface 2120 may receive incoming communications (such as requests or responses from other devices) in the form of one or more packets (such as Internet Protocol (IP) packets) from network 2130, and computer system 2100 may store the incoming communications in memory 2103 for processing. Computer system 2100 may similarly store outgoing communications (such as requests or responses to other devices) in the form of one or more packets in memory 2103 and communicated to network 2130 from network interface 2120. Processor(s) 2101 may access these communication packets stored in memory 2103 for processing.

Examples of the network interface 2120 include, but are not limited to, a network interface card, a modem, and any combination thereof. Examples of a network 2130 or network segment 2130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 2130, may employ a wired and/or a wireless mode of communication. In general, any network topology may be used.

Information and data can be displayed through a display 2132. Examples of a display 2132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 2132 can interface to the processor(s) 2101, memory 2103, and fixed storage 2108, as well as other devices, such as input device(s) 2133, via the bus 2140. The display 2132 is linked to the bus 2140 via a video interface 2122, and transport of data between the display 2132 and the bus 2140 can be controlled via the graphics control 2121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 2132, computer system 2100 may include one or more other peripheral output devices 2134 including, but not limited to, an audio speaker, a printer, a storage device, and any combinations thereof. Such peripheral output devices may be connected to the bus 2140 via an output interface 2124. Examples of an output interface 2124 include, but are not limited to, a serial port, a parallel connection, a USB port, a FIREWIRE port, a THUNDERBOLT port, and any combinations thereof.

In addition or as an alternative, computer system 2100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® P53®, Sony® P54®, Microsoft® Xbox 360®, Microsoft Xbox One, Nintendo® Wii®, Nintendo® Wii U®, and Ouya®. Non-transitory computer readable storage medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

Methods and systems of the present disclosure may be implemented by way of one or more algorithms. An algorithm may be implemented by way of software upon execution by the central processing unit. The algorithm may, for example, collect data from an imaging unit and analyze the data for evidence of defects in a manufactured roll-to-roll material or product.

In some embodiments, a computer program is created upon a software framework such as Microsoft®.NET or Ruby on Rails (RoR). In some embodiments, a computer program utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a computer program, in various embodiments, is written in one or more versions of one or more languages. A computer program may be written in one or more markup languages, presentation definition languages, client-side scripting languages, server-side coding languages, database query languages, or combinations thereof. In some embodiments, a computer program is written to some extent in a markup language such as Hypertext Markup Language (HTML), Extensible Hypertext Markup Language (XHTML), or eXtensible Markup Language (XML). In some embodiments, a computer program is written to some extent in a presentation definition language such as Cascading Style Sheets (CSS). In some embodiments, a computer program is written to some extent in a client-side scripting language such as Asynchronous Javascript and XML (AJAX), Flash® Actionscript, Javascript, or Silverlight. In some embodiments, a computer program is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, C++, Groovy. In some embodiments, a computer program is written to some extent in a database query language such as Structured Query Language (SQL). In some embodiments, a computer program integrates enterprise server products such as IBM® Lotus Domino®. In some embodiments, a computer program includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, C++, Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

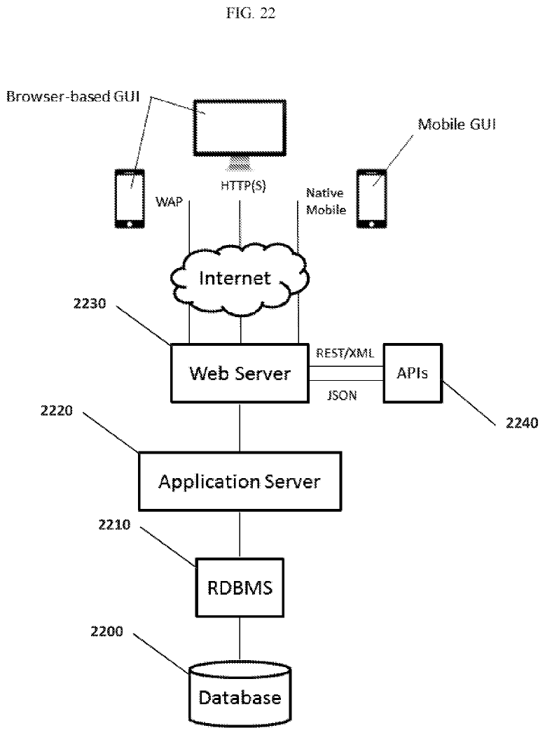

Referring to FIG. 22, in a particular embodiment, an application provision system comprises one or more databases 2200 accessed by a relational database management system (RDBMS) 0. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 2220 (such as Java servers, .NET servers, PHP servers, and the like) and one or more web servers 2230 (such as Apache, IIS, GWS and the like). The web server(s) optionally expose one or more web services via app application programming interfaces (APIs) 22400. Via a network, such as the Internet, the system provides browser-based and/or mobile native user interfaces.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. (canceled)

2. A computer-implemented method for defect detection and/or quality control, the method comprising:
(a) receiving one or more images of a roll-to-roll material formed by a machine, wherein the one or more images are associated with (i) a type of the roll-to-roll material and (ii) a light source scheme implemented for capture of the one or more images;
(b) applying a first machine learning algorithm based at least in part on the type of roll-to-roll material, the one or more images, and the light source scheme, to detect a defect in and/or to monitor the quality control of the roll-to-roll material;
(c) receiving verified data regarding the quality control, or whether the defect is present in the roll-to-roll material; and
(d) feeding back the verified data to improve a performance of the first machine learning algorithm over time.

3. The method of claim 2, further comprising generating one or more simulated images of the roll-to-roll material from the one or more images of the roll-to-roll material, wherein the applying the first machine learning algorithm comprises applying the first machine learning algorithm to the one or more images and the one or more simulated images.

4. The method of claim 3, wherein the generating the one or more simulated images of the roll-to-roll material from the one or more images of the roll-to-roll material comprises rotating an image, translating the image, skewing the image, modifying a brightness of the image, modifying a wavelength of the image, modifying a magnification of the image, modifying a contrast of the image, blurring the image, or any combination thereof.

5. The method of claim 2, wherein the first machine learning algorithm is trained by:
(a) constructing an initial model by assigning probability weights to predictor variables to the type of roll-to-roll material, the one or more images of the roll-to-roll material, and the light source scheme; and
(b) adjusting the probability weights based on the verified data.

6. The method of claim 2, wherein the first machine learning algorithm comprises a neural network, wherein the neural network is trained by:
(a) via a first training module, creating a first training set comprising:
(i) a first set of images, each image of the first set of images associated with the type of roll-to-roll material and light source scheme implemented while the image is captured; and
(ii) a second set of images, each image of the second set of images associated with the type of roll-to-roll material and light source scheme implemented while the image is captured;
wherein the first set of images are predetermined as displaying the defect, and
wherein the second set of images are predetermined as not displaying the defect;
(b) via the first training module, training the neural network using the first training set;
(c) via a second training module, creating a second training set for second stage training comprising the first training set and the images of the second set of images incorrectly detected as having a defect after the first stage of training; and
(d) training the neural network using the second training set.

7. The method of claim 2, further comprising:
(a) applying a second machine learning algorithm based at least in part on the one or more images, the type of roll-to-roll material, and the light source scheme, to detect a defect type of the defect in the roll-to-roll material;
(b) receiving verified data regarding the type of defect that exists in the roll-to-roll material; and
(c) feeding back the verified data to improve a performance of the second machine learning algorithm over time.

8. The method of claim 7, wherein the first machine learning algorithm, the second machine learning algorithm, or both, comprise an un-supervised machine learning algorithm.

9. The method of claim 7, further comprising generating one or more simulated images of the roll-to-roll material from the one or more images of the roll-to-roll material, wherein the applying the second machine learning algorithm to the one or more images comprises applying the second machine learning algorithm to the one or more images and the one or more simulated images.

10. The method of claim 9, wherein the generating the one or more simulated images of the roll-to-roll material from the one or more images of the roll-to-roll material comprises rotating an image, translating the image, skewing the image, modifying a brightness of the image, modifying a wavelength of the image, modifying a magnification of the image, modifying a contrast of the image, blurring the image, or any combination thereof.

11. The method of claim 7, wherein the second machine learning algorithm comprises a neural network, wherein the neural network is trained by:
(a) via a first training module, creating a first training set comprising:
(i) a first set of images, each image of the first set of images associated with the type of roll-to-roll material and light source scheme implemented while the image is captured; and
(ii) a second set of images, each image of the second set of images associated with the type of roll-to-roll material and light source scheme implemented while the image is captured;
wherein the first set of images are predetermined as displaying one or more of a plurality of defect types, and wherein the second set of images are predetermined as not displaying the one or more defect types;
(b) via the first training module, training the neural network using the first training set;
(c) via a second training module, creating a second training set for second stage training comprising the first training set and the images of the second set of images incorrectly detected as having a the one or more defect type after the first stage of training; and
(d) training the neural network using the second training set.

12. The method of claim 7, wherein the second machine learning algorithm is trained by:
(a) constructing an initial model by assigning probability weights to predictor variables to the type of roll-to-roll material, the one or more images of the roll-to-roll material, and the light source scheme; and
(b) adjusting the probability weights based on the verified data.

13. The method of claim 7, wherein the second machine learning algorithm is trained by:
(a) via a first training module, creating a first training set comprising a plurality of the images, each image of the plurality of images associated with the same type of roll-to-roll material and the same light source scheme implemented while the image is captured; wherein at most a first portion of the plurality of images are predetermined as displaying the same determined defect;
(b) via the first training module, training the second machine learning algorithm using the first training set;
(c) via a second training module, creating a second training set for second stage training comprising the first training set and the images not in the first portion that are incorrectly detected as having the determined defect after the first stage of training; and
(d) training the second machine learning algorithm using the second training set.

14. The method of claim 2, further comprising:
(a) receiving the one or more images of the roll-to-roll material, and
(b) applying a third machine learning algorithm to the one or more images to determine a quality of the one or more images;
(c) receiving verified data regarding the quality of the one or more images; and
(d) feeding back the verified data to improve a performance of the third machine learning algorithm over time.

15. The method of claim 14, wherein the third machine learning algorithm is trained by:
(a) via a first training module, creating a first training set comprising a plurality of the images, wherein a first portion of the plurality of images are predetermined as having a sufficient quality, and wherein a second portion of the plurality of images are predetermined as having an insufficient quality;
(b) via the first training module, training the third machine learning algorithm using the first training set;
(c) via a second training module, creating a second training set for second stage training comprising the first training set and the images in the second plurality of images incorrectly detected as having the sufficient quantity; and
(d) training the third machine learning algorithm using the second training set.

16. The method of claim 14, wherein the third machine learning algorithm is trained by:
(a) via a first training module, creating a first training set comprising a plurality of the images, each image of the plurality of images associated with a quality index;
(b) via the first training module, training the third machine learning algorithm using the first training set;
(c) via a second training module, creating a second training set for second stage training comprising the first training set and the images in the plurality of images whose quality index was incorrectly determined beyond a set quality value; and
(d) training the third machine learning algorithm using the second training set.

17. The method of claim 2, wherein the roll-to-roll material comprises a textile, a metal or metal alloy, a paper, a plastic, or a wood.

18. The method of claim 2, wherein the roll-to-roll material comprises a textile, and wherein the defect comprises a hole defect, a needle defect, a lycra defect, a lycra dashed defect, a yarn thickness defect, a yarn color defect, a double yarn defect, a periodicity defect, or any combination thereof.

19. The method of claim 2, wherein the roll-to-roll material is a sheet of roll-to-roll material.

20. The method of claim 2, wherein the machine is a knitting machine or a weaving machine.

21. The method of claim 2, wherein the machine is a circular knitting machine or a circular weaving machine.
